(19) United States
(12) Patent Application Publication
(10) Pub. No.: US 2016/0116274 A1
(43) Pub. Date: Apr. 28, 2016

(54) MOBILITY BASED LOCATION DETERMINATION

(71) Applicant: AT&T Mobility II LLC, Atlanta, GA (US)

(72) Inventors: Sheldon Kent Meredith, Roswell, GA (US); Jeremy Fix, Acworth, GA (US); Rick Tipton, Corryton, TN (US)

(21) Appl. No.: 14/524,534

(22) Filed: Oct. 27, 2014

(51) Int. Cl. G01B 21/00; H04W 4/02

(52) U.S. Cl. CPC G01B 21/00; H04W 4/021; H04W 4/028

(57) ABSTRACT

A determination as to whether a device is within a region may be based on an accuracy of a determined location of the device and on a mobility status of the device. For example, upon a determination that a device is moving, the device may be removed from candidate devices that may otherwise be determined to be at or within a particular location. In example aspects, a location may be a geographic spatial location, a geofence, a logical fence, or any appropriate combination thereof.

### TECHNICAL FIELD

The technical field generally relates to determining whether a device is within a region, and more specifically relates to considering mobility of a device when determining whether the device is within a region.

### BACKGROUND

An entity may want to know if a person is within a region. For example, a telecommunications network provider may want to know the locations of its customers, marketing agencies may want to know the locations of persons of a particular demographic, government agencies may want to know the locations of persons of interest, law enforcement entities may want to know the locations of designated persons (e.g., persons under a restraining order, persons on probation, persons on parole, etc.). One way to determine whether person is within a region is to estimate the location of a communications device (e.g., smart phone, tablet, etc.) associated with the person and infer that the person is at the estimated location. However, estimated locations of a communications device may be inaccurate for various reasons. And if decisions (e.g., parole/restraining order violation, cell coverage, etc.) are to be made based on estimated locations, it may be ill-advised to base such decisions on inaccurate estimations.

### SUMMARY

The following presents a simplified summary that describes some aspects or configurations of the subject disclosure. This summary is provided to introduce a selection of concepts in a simplified form that are further described below in the Detailed Description. This summary is not intended to identify key features or essential features of the claimed subject matter, nor is it intended to be used to limit the scope of the claimed subject matter. This summary is not an extensive overview of the disclosure. Indeed, additional or alternative configurations of the subject disclosure may be available beyond those described in the summary.

As described herein, a determination as to whether a device is within a region may be based, at least in part, an accuracy of a determined location of the device and on a mobility status (e.g., moving, stationary, speed, velocity, etc.) of the device. For example, upon a determination that a device is moving, the device may be removed from candidate devices that may otherwise be determined to be at or within a particular location. In example configurations, mobility status may be utilized to generate the candidate list. In example aspects, a location may be a geographic spatial location (e.g., latitude and longitude), a geospatial region (referred to herein as a geofence), a region determined by observation of telecommunications equipment (referred to herein as a logical fence), or any appropriate combination thereof.

### BRIEF DESCRIPTION OF THE DRAWINGS

Aspects of the herein disclosure are described more fully herein with reference to the accompanying drawings, in which example aspects are shown. In the following description, for purposes of explanation, numerous specific details are set forth in order to provide an understanding of the various aspects. However, the instant disclosure may be embodied in many different forms and should not be construed as limited to the example aspects set forth herein. Like numbers refer to like elements throughout.

FIG. 1 is a flow diagram of an example process for determining location based on mobility.

FIG. 2 is a flow diagram of another example process for determining location based on mobility.

FIG. 3 is a flow diagram of another example process for determining location based on mobility.

FIG. 4 is a flow diagram of another example process for determining location based on mobility.

FIG. 5 is a flow diagram of an example process for pre-computing the probability of being within a particular geofence.

FIG. 6 is a flow diagram of an example process for providing a probabilistic determination of geofence collision.

FIG. 7 is a block diagram of an example device that may be utilized with mobility based location determination.

FIG. 8 is a block diagram of network entity of a communication network which may be utilized in conjunction with mobility based location determination.

FIG. 9 is a diagram of an example communications system that may be utilized to effectuate mobility based location determination.

FIG. 10 is a system diagram of an example WTRU which may be utilized to facilitate mobility based location determination.

FIG. 11 is an example system diagram of RAN and a core network that may be utilized to effectuate mobility based location determination.

FIG. 12 depicts an overall block diagram of an example packet-based mobile cellular network environment, such as a GPRS network, that may be utilized to effectuate mobility based location determination.

FIG. 13 illustrates an architecture of a typical GPRS network that may be utilized to effectuate mobility based location determination.

FIG. 14 illustrates an example block diagram view of a GSM/GPRS/IP multimedia network architecture that may be utilized to effectuate mobility based location determination.

FIG. 15 illustrates a PLMN block diagram view of an example architecture that may be utilized to effectuate mobility based location determination.

### DETAILED DESCRIPTION

Systems and/or methods described herein may provide the ability to determine that a communications device is moving and to exclude it from a pool of candidate communications devices that would otherwise be claimed as being present at a geofence (geospatial region) or a logical fence (region determined by observation of a nearby radio). In example configurations, location records comprising estimated locations of the communications devices may be spatially filtered to determine if a communications device is within or is not within a geofence, logical fence, or the like. The mobility status of each communications device may be determined Mobility status may indicate that a communications device is moving, that a communications device is stationary, a rate of speed at which a communications device is moving, a velocity (speed and direction) at which a communications device is moving, or the like, or any appropriate combination thereof. It may be determined if the mobility status is acceptable or not acceptable. A mobility status may be determined to be acceptable for any appropriate reason or reasons. For example, a mobility status may be determined to be acceptable if a speed of a communications device is less than (slower than) a threshold speed, if a velocity of a communications device is within a threshold range of velocities, if a communications device is determined to be stationary, if the mobility status is determined to be an anomaly as compared to other mobility statuses for the communication device, or the like, or any appropriate combination thereof.

A mobility status may be determined not to be acceptable (unacceptable) for any appropriate reason or reasons. For example, a mobility status may be determined to be unacceptable if a speed of a communications device is greater than (faster than) a threshold speed, if a velocity of a communications device is not within a threshold range of velocities, if a communications device is determined not to be stationary, if the mobility status is determined not to be an anomaly as compared to other mobility statuses for the communication device, or the like, or any appropriate combination thereof.

If the mobility status of a communications device is determined to be acceptable, it may be included in the candidate list of communications devices. If the mobility status of a communications device is determined not to be acceptable, it may be excluded from the candidate list of communications devices.

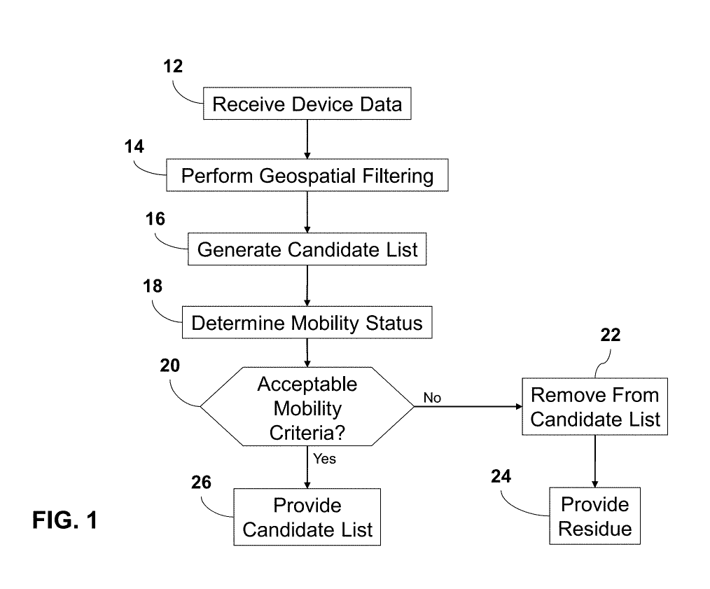

FIG. 1 is a flow diagram of an example process for determining location based on mobility. At step 12, device data may be received. Device data may comprise any appropriate data regarding the device, such as, for example, an identification of the device, a phone number associated with the device, the type of the device, feature of the device, a model number of the device, a serial number of the device, a subscriber associated with the device, a location of the device, location coordinates (e.g., latitude, longitude), a time stamp, subscriber information, whether or not the device is moving, a speed at which the device is moving, a direction in which the device is moving, a velocity of motion of the device, or the like, or any appropriate combination thereof. Device data may be received for a single device or a plurality of devices. Device data may be accumulated over time.

Geospatial filtering may be performed at step 14. Geospatial filtering may be performed to determine if a device is within a geographic region. Geospatial filtering may be accomplished in any appropriate manner. Geospatial filtering is described in more detail below.

A candidate list may be generated at step 16. The candidate list may indicate a device, or list of devices, that are determined, based on the geospatial filtering performed at step 14, to be within a geographic region. Responsive to receiving device data (step 12) and performing geospatial filtering (step 14), devices may be added to and/or removed from the candidate list at step 16.

Mobility status of the device may be determined at step 18. Mobility status may comprise any appropriate indication regarding mobility of the device. For example, mobility status may indicate that the device is stationary (not moving), mobility status may indicate that the device is moving (not stationary), mobility status may indicate the speed at which a device is moving, mobility status may indicate a direction in which the device is moving, mobility status may indicate a velocity (e.g., speed and direction) of the device, or the like, or any appropriate combination thereof. Mobility status may be determined in any appropriate manner. For example, mobility status may be contained in the device data received at step 12 (e.g., speed, direction, velocity, stationary, nonstationary, etc.), mobile status may be derived based on the device data received at step 12 (e.g., divide distance data by speed data, perform derivative of distance date with respect to time, etc.), or the like, or any appropriate combination thereof.

At step 20, it may be determined if the mobility status (determined at step 18) for a device is acceptable or not acceptable (unacceptable). An acceptable mobility status may comprise any appropriate mobility status that would result in the device remaining on the candidate list. An unacceptable mobility status may comprise any appropriate mobility status that would result in the device being removed (or excluded) from the candidate list.

The mobility status of a device may be determined to be acceptable, for example, if the device is stationary, if the speed at which the device is moving is equal to or less than a threshold speed (e.g., 10 feet per second, 100 feet per second, 1 mile per hour, 3 miles per hour, etc.); if the direction toward which the device is moving is within a range of acceptable directions (e.g., compass direction such as north, south, east, west, etc.; toward a geographic region or location, such as toward a geofence or logical fence; toward a landmark, building, or the like); if the velocity of the device is within a range of acceptable velocities (e.g., acceptable speed and acceptable direction, acceptable speed regardless of direction, acceptable direction regardless of speed, etc.); or the like, or any appropriate combination thereof.

The mobility status of a device may be determined to be unacceptable, for example, if the device is not stationary, if the speed at which the device is moving is greater than a threshold speed (e.g., 10 feet per second, 100 feet per second, 1 mile per hour, 3 miles per hour, etc.); if the direction toward which the device is moving is not within a range of acceptable directions (e.g., not in a compass direction such as north, south, east, west, etc.; not toward a geographic region or location, such as toward a geofence or logical fence; toward a landmark, building, or the like); if the velocity of the device is not within a range of acceptable velocities (e.g., unacceptable speed and unacceptable direction, unacceptable speed regardless of direction, unacceptable direction regardless of speed, etc.); or the like, or any appropriate combination thereof.

If it is determined, at step 20, that the mobility status of a device is unacceptable, the device may be removed from the candidate list at step 22. An indication of the residual candidates remaining on the list may be provided to any appropriate entity at step 24. If it is determined, at step 20, that the mobility status of a device is acceptable, the device may remain on the candidate list, and the candidate list may be provided to any appropriate entity at step 26.

For illustrative purposes, in an example scenario, an acceptable mobility status based on velocity may comprise a velocity having an acceptable speed (e.g., less than 1 mile per hour) and having an unacceptable direction (e.g., heading out of a geofence). In this example scenario, it has been determined that the boundary of the geofence toward which the device is heading is far enough away (e.g., ½ mile) from the current location of the device that, at the speed the device is moving (less than 1 mile per hour) it would take the device over ½ hour to reach the boundary. Thus, the mobility status may be determined to be acceptable for the instant determination. Note however, that as time progresses, as the device gets closer to the boundary, the mobility status, based on velocity, may be determined to be unacceptable.

In another example scenario, an acceptable mobility status based velocity may comprise a velocity having an unacceptable speed (e.g., greater than 3 miles per hour) and having an acceptable direction (e.g., heading toward a building which is within a geofence). In this example scenario, it may be determined that the building is the workplace of a subscriber associated with the device and that the device is a short distance (e.g., a few blocks) away from the building. Thus it may be inferred that the device will be entering the geofence.

Location determination based on mobility may be accomplished in any appropriate manner. It is to be understood that acts depicted in FIG. 1 may be performed in any appropriate sequence and/or concurrency, and that the sequence/concurrency of acts depicted in FIG. 1 is not to be construed as limited thereto.

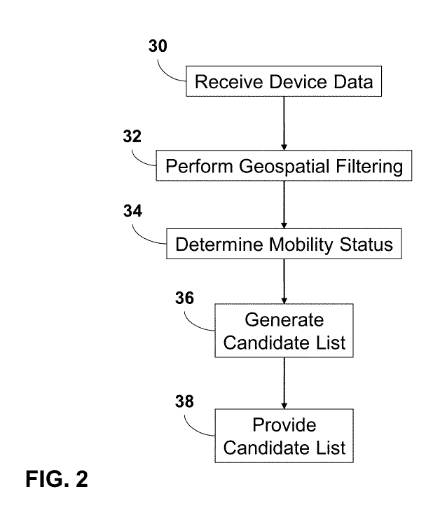

For example, FIG. 2 is a flow diagram of another example process for determining location based on mobility. As depicted in FIG. 2, spatial filtering may be performed on a device and the mobility status of the device may be utilized to generate the candidate list. Thus devices may be filtered geospatially and on mobility status prior to generating the candidate list.

Consequently, device data may be received at step 30. As described with respect to FIG. 1 (step 12), and similarly in FIG. 2, device data may comprise any appropriate data regarding the device, such as, for example, an identification of the device, a phone number associated with the device, the type of the device, feature of the device, a model number of the device, a serial number of the device, a subscriber associated with the device, a location of the device, location coordinates (e.g., latitude, longitude), a time stamp, subscriber information, whether or not the device is moving, a speed at which the device is moving, a direction in which the device is moving, a velocity of motion of the device, or the like, or any appropriate combination thereof. Device data may be received for a single device or a plurality of devices. Device data may be accumulated over time.

Geospatial filtering may be performed at step 32. Geospatial filtering may be performed to determine if a device is within a geographic region. Geospatial filtering may be accomplished in any appropriate manner. Geospatial filtering is described in more detail below.

Mobility status of the device may be determined at step 34. Mobility status may comprise any appropriate indication regarding mobility of the device. For example, mobility status may indicate that the device is stationary (not moving), mobility status may indicate that the device is moving (not stationary), mobility status may indicate the speed at which a device is moving, mobility status may indicate a direction in which the device is moving, mobility status may indicate a velocity (e.g., speed and direction) of the device, or the like, or any appropriate combination thereof. Mobility status may be determined in any appropriate manner. For example, mobility status may be contained in the device data received at step 30 (e.g., speed, direction, velocity, stationary, nonstationary, etc.), mobile status may be derived based on the device data received at step 30 (e.g., divide distance data by speed data, perform derivative of distance date with respect to time, etc.), or the like, or any appropriate combination thereof.

A candidate list may be generated at step 36. The candidate list may indicate a device, or list of devices, that are determined, based on the geospatial filtering performed at step 32, and based on mobility status determined at step 34, to be within a geographic region. Responsive to receiving device data (step 30), performing geospatial filtering (step 32), and determining mobility status (step 34), devices may be added to and/or removed from the candidate list at step 36. The candidate list may be provided to any appropriate entity at step 38.

It is to be understood that acts depicted in FIG. 2 may be performed in any appropriate sequence and/or concurrency, and that the sequence/concurrency of acts depicted in FIG. 2 is not to be construed as limited thereto. For example, mobility status (step 34) may be performed prior to performing geospatial filtering (step 32).

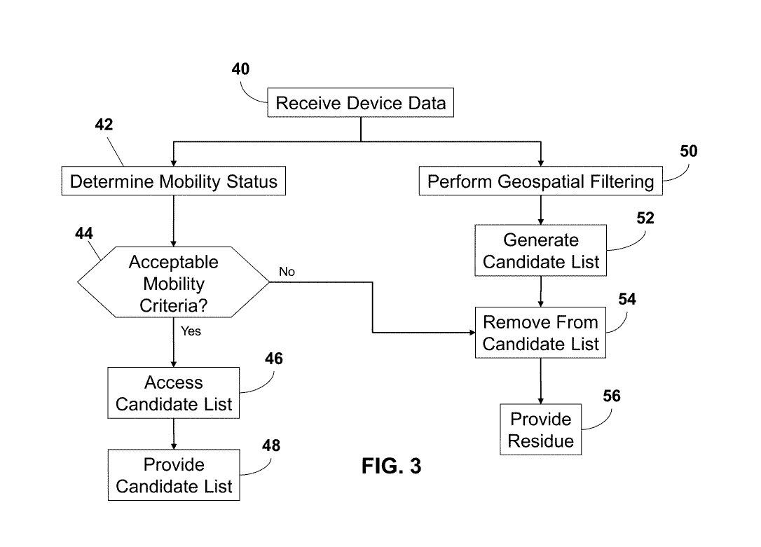

FIG. 3 is a flow diagram of another example process for determining location based on mobility. As depicted in FIG. 3, mobility status and geospatial filtering may be performed concurrently, or approximately concurrently.

As depicted in FIG. 3, device data may be received at step 40. As described above with respect to FIG. 1 and FIG. 2, device data may comprise any appropriate data regarding the device, such as, for example, an identification of the device, a phone number associated with the device, the type of the device, feature of the device, a model number of the device, a serial number of the device, a subscriber associated with the device, a location of the device, location coordinates (e.g., latitude, longitude), a time stamp, subscriber information, whether or not the device is moving, a speed at which the device is moving, a direction in which the device is moving, a velocity of motion of the device, or the like, or any appropriate combination thereof. Device data may be received for a single device or a plurality of devices. Device data may be accumulated over time.

Mobility status of the device may be determined at step 42. Mobility status may comprise any appropriate indication regarding mobility of the device. For example, mobility status may indicate that the device is stationary (not moving), mobility status may indicate that the device is moving (not stationary), mobility status may indicate the speed at which a device is moving, mobility status may indicate a direction in which the device is moving, mobility status may indicate a velocity (e.g., speed and direction) of the device, or the like, or any appropriate combination thereof. Mobility status may be determined in any appropriate manner. For example, mobility status may be contained in the device data received at step 40 (e.g., speed, direction, velocity, stationary, nonstationary, etc.), mobile status may be derived based on the device data received at step 40 (e.g., divide distance data by speed data, perform derivative of distance date with respect to time, etc.), or the like, or any appropriate combination thereof.

Geospatial filtering may be performed at step 50. Geospatial filtering may be performed to determine if a device is within a geographic region. Geospatial filtering may be accomplished in any appropriate manner. Geospatial filtering is described in more detail below.

A candidate list may be generated at step 52. The candidate list may indicate a device, or list of devices, that are determined, based on the geospatial filtering performed at step 50 to be within a geographic region. Responsive to receiving device data (step 40) and performing geospatial filtering (step 50), devices may be added to and/or removed from the candidate list at step 52.

At step 44, it may be determined if the mobility status (determined at step 42) for a device is acceptable or not acceptable (unacceptable). An acceptable mobility status may comprise any appropriate mobility status that would result in the device remaining on the candidate list. An unacceptable mobility status may comprise any appropriate mobility status that would result in the device being removed (or excluded) from the candidate list.

The mobility status of a device may be determined to be acceptable, for example, if the device is stationary, if the speed at which the device is moving is equal to or less than a threshold speed (e.g., 10 feet per second, 100 feet per second, 1 mile per hour, 3 miles per hour, etc.); if the direction toward which the device is moving is within a range of acceptable directions (e.g., compass direction such as north, south, east, west, etc.; toward a geographic region or location, such as toward a geofence or logical fence; toward a landmark, building, or the like); if the velocity of the device is within a range of acceptable velocities (e.g., acceptable speed and acceptable direction, acceptable speed regardless of direction, acceptable direction regardless of speed, etc.); or the like, or any appropriate combination thereof.

The mobility status of a device may be determined to be unacceptable, for example, if the device is not stationary, if the speed at which the device is moving is greater than a threshold speed (e.g., 10 feet per second, 100 feet per second, 1 mile per hour, 3 miles per hour, etc.); if the direction toward which the device is moving is not within a range of acceptable directions (e.g., not in a compass direction such as north, south, east, west, etc.; not toward a geographic region or location, such as toward a geofence or logical fence; toward a landmark, building, or the like); if the velocity of the device is not within a range of acceptable velocities (e.g., unacceptable speed and unacceptable direction, unacceptable speed regardless of direction, unacceptable direction regardless of speed, etc.); or the like, or any appropriate combination thereof.

If it is determined, at step 44, that the mobility status of a device is unacceptable, the device may be removed from the candidate list at step 54. An indication of the residual candidates remaining on the list may be provided to any appropriate entity at step 56. If it is determined, at step 44, that the mobility status of a device is acceptable, the device may remain on the candidate list. The candidate list, generate at step 52, may be accessed at step 46. And the candidate list may be provided to any appropriate entity at step 48.

It is to be understood that acts depicted in FIG. 3 may be performed in any appropriate sequence and/or concurrency, and that the sequence/concurrency of acts depicted in FIG. 3 is not to be construed as limited thereto.

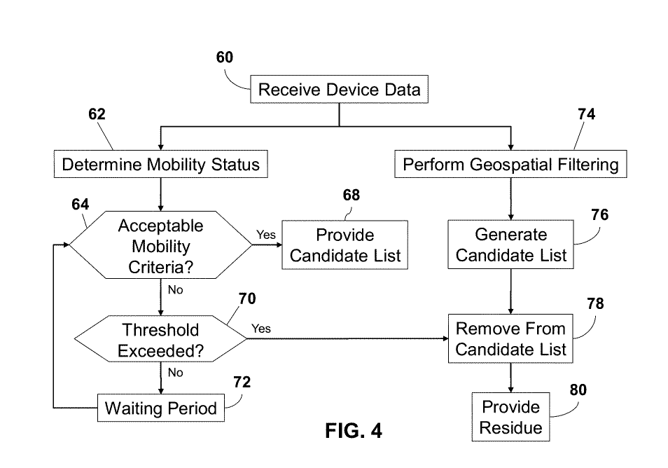

FIG. 4 is a flow diagram of another example process for determining location based on mobility. As depicted in FIG. 4, device data may be received at step 60. As described above with respect to FIG. 1, FIG. 2, and FIG. 3, device data may comprise any appropriate data regarding the device, such as, for example, an identification of the device, a phone number associated with the device, the type of the device, feature of the device, a model number of the device, a serial number of the device, a subscriber associated with the device, a location of the device, location coordinates (e.g., latitude, longitude), a time stamp, subscriber information, whether or not the device is moving, a speed at which the device is moving, a direction in which the device is moving, a velocity of motion of the device, or the like, or any appropriate combination thereof. Device data may be received for a single device or a plurality of devices. Device data may be accumulated over time.

Mobility status of the device may be determined at step 62. Mobility status may comprise any appropriate indication regarding mobility of the device. For example, mobility status may indicate that the device is stationary (not moving), mobility status may indicate that the device is moving (not stationary), mobility status may indicate the speed at which a device is moving, mobility status may indicate a direction in which the device is moving, mobility status may indicate a velocity (e.g., speed and direction) of the device, or the like, or any appropriate combination thereof. Mobility status may be determined in any appropriate manner. For example, mobility status may be contained in the device data received at step 60 (e.g., speed, direction, velocity, stationary, nonstationary, etc.), mobile status may be derived based on the device data received at step 60 (e.g., divide distance data by speed data, perform derivative of distance date with respect to time, etc.), or the like, or any appropriate combination thereof.

Geospatial filtering may be performed at step 74. Geospatial filtering may be performed to determine if a device is within a geographic region. Geospatial filtering may be accomplished in any appropriate manner. Geospatial filtering is described in more detail below.

A candidate list may be generated at step 76. The candidate list may indicate a device, or list of devices, that are determined, based on the geospatial filtering performed at step 50 to be within a geographic region. Responsive to receiving device data (step 60) and performing geospatial filtering (step 74), devices may be added to and/or removed from the candidate list at step 76.

At step 64, it may be determined if the mobility status (determined at step 62) for a device is acceptable or not acceptable (unacceptable). An acceptable mobility status may comprise any appropriate mobility status that would result in the device remaining on the candidate list. An unacceptable mobility status may comprise any appropriate mobility status that would result in the device being removed (or excluded) from the candidate list.

The mobility status of a device may be determined to be acceptable, for example, if the device is stationary, if the speed at which the device is moving is equal to or less than a threshold speed (e.g., 10 feet per second, 100 feet per second, 1 mile per hour, 3 miles per hour, etc.); if the direction toward which the device is moving is within a range of acceptable directions (e.g., compass direction such as north, south, east, west, etc.; toward a geographic region or location, such as toward a geofence or logical fence; toward a landmark, building, or the like); if the velocity of the device is within a range of acceptable velocities (e.g., acceptable speed and acceptable direction, acceptable speed regardless of direction, acceptable direction regardless of speed, etc.); or the like, or any appropriate combination thereof.

The mobility status of a device may be determined to be unacceptable, for example, if the device is not stationary, if the speed at which the device is moving is greater than a threshold speed (e.g., 10 feet per second, 100 feet per second, 1 mile per hour, 3 miles per hour, etc.); if the direction toward which the device is moving is not within a range of acceptable directions (e.g., not in a compass direction such as north, south, east, west, etc.; not toward a geographic region or location, such as toward a geofence or logical fence; toward a landmark, building, or the like); if the velocity of the device is not within a range of acceptable velocities (e.g., unacceptable speed and unacceptable direction, unacceptable speed regardless of direction, unacceptable direction regardless of speed, etc.); or the like, or any appropriate combination thereof.

If it is determined, at step 64, that the mobility status of a device is acceptable, the device may remain on the candidate list. The candidate list, generated at step 76, may be accessed and provided to any appropriate entity at step 68.

If it is determined, at step 64, that the mobility status of a device is unacceptable, it may be determined, at step 70, if a threshold amount of attempts to determine if the mobility status has been exceeded. The threshold amount of attempts may comprise any appropriate number of attempts, such as for example, one attempt, 5 attempts, 10 attempts, or the like.

If it is determined, at step 70, that a threshold amount of attempts has not been exceeded, the mobility status again may be determined at step 64, upon waiting an amount of time at step 72. The amount of time to be waited (waiting period) may be any appropriate time, such as, for example, 1 second, 1 minute, 5 minutes, 10 minutes, 30 minutes, 1 hour, or the like.

If it is determined, at step 70, that a threshold amount of attempts has been exceeded, the device may be removed from the candidate list at step 78. An indication of the residual candidates remaining on the list may be provided to any appropriate entity at step 80.

It is to be understood that acts depicted in FIG. 4 may be performed in any appropriate sequence and/or concurrency, and that the sequence/concurrency of acts depicted in FIG. 4 is not to be construed as limited thereto.

Geospatial filtering may be accomplished in any appropriate manner. In an example configuration, the probability of a device being in the particular geofence may be determined in accordance with an accuracy level associated with a location record of the device (also referred to herein as a mobile user endpoint device). For example, received device data may comprise a mobile identification for a mobile user endpoint device, a location record for the mobile user endpoint device, and an accuracy level associated with the location record of the mobile user endpoint device. A bin in a database may be identified, and using the location record that is received for the mobile user endpoint device, one or more geofences may be identified in which the bin is located. Using the identified bin as an index, one or more geofences that are associated with the mobile user endpoint device may be identified. Using the received mobile identification, an intersection of the one or more geofences that are identified as being associated with the user endpoint device and the one or more geofences that are identified as being geofences in which the bin is located, may be determined. For each particular geofence in the intersection that is determined, the probability of being in the particular geofence may be determined, wherein the probability of being in the particular geofence is determined in accordance with the accuracy level associated with the location record of the mobile user endpoint device. In an example configuration, a determination that a device is within a geographic region may be based on the probability being greater than or equal to a threshold probability. In an example configuration, a determination that a device is not within a geographic region may be based on the probability being less than a threshold probability.

As described above, an entity may want to know if a person is within a region. For example, a network service provider may wish to have accurate knowledge of the locations of its customers. A customer may interact with the service provider via a base station that the customer's endpoint device is using to obtain a service. Because the wireless coverage in the vicinity of the customer may depend on the proximity of the customer's endpoint device to the cell tower, a geofence may be defined for an area considered to be inside the coverage area of the cell tower. The service provider may make a determination as to whether the customer is considered to be in or out of a particular geofence, when the customer's endpoint device is interacting with the service provider's cell towers. However, such reporting method may be inaccurate, e.g., reporting that a customer's current location is within a geofence, when in fact the actual location of the customer's endpoint device is outside the geofence. This inaccuracy may be due to the e boundary of a geofence being poorly correlated to the boundary of the coverage area. Given such inaccuracy, a service provider may benefit from the knowledge of the probability of the actual location of a customer being within the geofence, when the reported location is within the geofence. Thus, the determination that a device is in or out of a geofence may be qualified.

A probabilistic determination of geofence collision (whether an entity is within or out of a geofence) in a wireless network is provided herein. As described herein, mobility based location determination may be implemented via a wireless network that may require a determination of the geofence collisions and probabilities at high speed and high volume processing. For example, the number of geofences for a wireless network may be on the order of millions and the number of location records to be processed may be several hundred thousand records per second. In addition, location records may be processed in real time, e.g., in less than about 10 seconds. In example configurations, computations that take significant amount of computational resources may initially be performed once and then stored. Subsequently, computations for processing of received locations at high volume and speed may be accomplished in real time with lesser impact on resources.

Geofences may be generated via any appropriate process/mechanism. In an example configuration, a geofence may be generated via Tessellation. Tessellation refers to a technique for dividing up a geographical area into tiles or bins. An example Tessellation referred to as Military Grid Reference System (MGRS) may be utilized. Although utilization of MGRS is described herein to generate a geofence, it is to be understood that any appropriate process/mechanism for generating a geofence may be utilized.

In an example aspect of determining a probability of an entity being within or out of a geofence, all bins having centers within each geofence may be determined. The center of a geofence may be defined assuming that the geofence is shaped like a circle, a polygon, etc. A list of bins within each geofence may be stored in a database or the like. For each particular bin in the list of bins, a list of geofences that the particular bin is within may be generated. For example, a particular bin may be in a plurality of geofences, e.g., in a first geofence encompassing a business location, in a second geofence encompassing a neighborhood, in a third geofence encompassing a township, in a fourth geofence encompassing a state, in a fifth geofence encompassing a country, or the like, or any appropriate combination thereof. A list of geofences for each bin may be stored, for example, in a database, or the like. Each of the geofences in which the bin is located may refer to the same bin using a unique identifier.

When location records are received, the location records may be expressed in terms of a physical latitudinal and longitudinal location of the user endpoint device. The location records may have varying accuracy levels. For example, a small geofence, e.g., on the order of a few hundred meters, may have a location accuracy of 10 meters or less, or a large geofence may have a location accuracy of on the order of a kilometer. The accuracy level may be a factor in determining the probability of the actual location of a user endpoint device being within a geofence.

For example, if the earth is divided into two geofences: one for northern hemisphere and another for southern hemisphere, the equator may be used as the boundary between the two geofences. If the location record indicates a location that is directly on the equator, regardless of accuracy, the location has a 50% chance of being in the geofence of the northern hemisphere. If the location record indicates that the location is centered 100 meters north of the equator, the accuracy level becomes a factor for asserting the probability of the location being in the geofence of the northern hemisphere. In a first example, if the error on the location is such that the standard deviation is 10 meters, the probability of the reported location being in the geofence of the northern hemisphere is virtually 100% (for practical applications). In a second example, if the error on the location is such that the standard deviation is large, e.g., 1 kilometers, the probability of the reported location being in the geofence of the northern hemisphere may be much smaller, e.g., 70%.

As illustrated by the above exemplary scenario, if the accuracy level of a location is low, simply determining whether a customer is in or out of a geofence may not provide enough information to ascertain the actual location of a customer. The negative effect is that the customer may quickly become dissatisfied with the lack of accuracy of the location service. Determining whether an entity is in or out of a geofence as described herein, may provide a technical advantage by enabling a service provider to determine the probability of the actual location of the customer being in the geofence when a reported location for the customer is determined as being in the geofence.

In one configuration, in order to determine probabilities in real time for processing a high volume of location records, probabilities of being within one or more particular geofences as a function of the accuracy level may be pre-computed and stored in a database, memory, or the like. Then, in real-time, the method determines the probability of being in a particular geofence by simply looking up in the database based on the location accuracy.

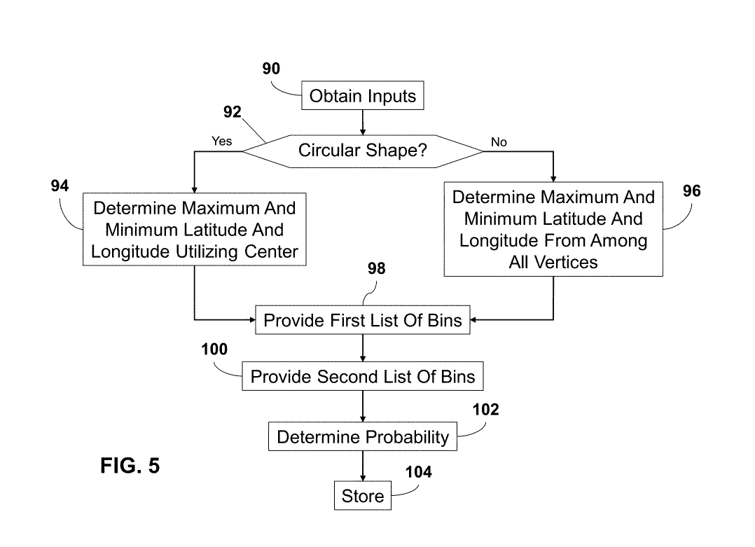

FIG. 5 is a flow diagram of an example process for pre-computing the probability of being within a particular geofence, when a location is reported as being in a bin associated with the geofence. At step 90, inputs may be obtained for defining, e.g., a boundary for each geofence, excluded areas, a length of a bin, and one or more error codes with each error code corresponding to an amount of error measured in distance (broadly an accuracy level), e.g., in a number of meters. For example, boundaries may be received for defining the particular geofence and for setting a length for each bin, e.g., for each MGRS bin.

At step 92, it may be determined if the boundaries of the geofence are for a geofence of a circular shape. If the geofence is of a circular shape, the process may proceed to step 94. Otherwise, the process may proceed to step 96.

At step 94, a maximum and a minimum latitude, and a maximum and a minimum longitude using a center of a circle may be determine, wherein the boundary of the circle may define the geofence. From step 94, the process may proceed to step 98.

At step 96, a maximum and a minimum latitude, and a maximum and a minimum longitude may be determined from among all vertices of the geofence. From step 96, the process may proceed to step 98.

At step 98, a first list of bins may be provided. The first list of bins may be populated by determining all bins within a polygon (e.g., rectangle, etc.) in accordance with the length of the bin that is received, wherein the polygon (e.g., rectangle, etc.) may be defined by a range of latitude expanded by a predetermined distance in each direction and a range of longitude expanded by the predetermined distance in each direction. For example, each of four sides of the rectangle may be expanded by the predetermined distance, e.g., by 100 meters. The bins within the rectangle may then be provided in the first list.

At step 100, a second list of bins may be provided. The second list of bins may be populated by removing from the first list, all bins that are entirely external to the geofence and all bins that are entirely in an excluded area within the geofence. For example, if the geofence is defined for an area with a pond, and the area comprising the pond is excluded, bins that are entirely falling within the excluded area may be removed.

At step 102, for each particular bin in the first list, a probability of being in the geofence may be determined for each particular error code. For example, if there are n error codes, the probability of being in the geofence when a location is reported as being in the particular bin in the first list, may be determined for each of the n error codes.

In an example configurator, the probability of being in the geofence as a summation of probabilities may be determined, wherein the summation may be performed over all bins in the second list. For example, each bin in the geofence that is not excluded may contribute towards the probability computations for other bins inside the geofence.

In an example configuration, the probability of being in the geofence may be computed as the summation in accordance with the equation defined below.

Let, G(BIN, EC) represent the probability of being in the geofence for bin of interest (BIN) for an error code (EC). Then, G(BIN, EC) may be represented as a summation of contributions towards the probability of the BIN from each bin in the second list. For ease of reference, the particular bin for which the probability contribution is being computed may be referred to as Bin To Accumulate (BTA). Each BTA is then a bin from the second list, and the summation is performed over BTAs that comprise all bins in the second list. Accordingly, mathematically G(BIN, EC) may be computed as follows.

$$\begin{matrix}G ( BIN , EC ) = {\sum }_{∀ BTA ∈ second list} F ( BTA ) , & ( 1 ) \\ Wherein , & \\ F ( BTA ) = \frac{E \times {A}^{2}}{π ( {( C + 0.5 A )}^{2} - {( C - 0.5 A )}^{2} )} , & \\ E = \{ \begin{matrix}Erf ( 0 ) - Erf ( - \frac{0.525 \times \frac{A}{B}}{\sqrt{2}} ) , & for D = 0 \\ Erf ( - \frac{( D - 0.525 \frac{A}{B} )}{\sqrt{2}} ) - Erf ( - \frac{( D + 0.525 \frac{A}{B} )}{\sqrt{2}} ) , & for D \neq 0\end{matrix} & \end{matrix}$$

wherein, Erf is a Gaussian error function,

D=Gaussian distance from BTA to

$$BIN = 1.05 \frac{C}{B} ,$$

C=Distance in meters between the BTA and the BIN,

B=Error code in meters,

A=Bin length.

In an example configuration, bins outside of the geofence that are located within a predetermined distance from the boundary of the geofence, also may contribute towards the probability computations of bins that are located inside the geofence. For example, bins within 20% of the range of latitudinal and longitudinal coordinates may contribute.

At step 104, for each particular bin in the first list, the probability of being in the geofence that is determined in step 220, for each particular error code may be stored in a database, memory, or the like. For example, if there are 10 bins in the first list with each of the 10 bins having two error codes, and there is one geofence, 20 probabilities of the actual location of the endpoint device being in the geofence may be computed and stored. Each probability may be computed for a combination of one particular bin in which a location may be reported by the user endpoint device and one particular error code for the location that may be reported.

Once the database is populated with the probabilities for all geofences, the probabilities of being in particular geofences (e.g., during processing of a received location of a user endpoint device) may be retrieved in real time. Thus, the stored information may be used to assist a location service to determine whether a reported location of a customer endpoint device is within a particular geofence.

As described above, real time processing may be based on a received location of a mobile user or customer endpoint device. In some scenarios, the user may frequently travel with the user endpoint device among a limited set of locations. For example, a user may be traveling to a particular work address, to a particular store, to a particular ballpark, etc. with his/her cell phone. Most of the locations reported for the cell phone may then be associated with one of the frequently visited places. Mobility based location determination as described herein may further reduce the processing required in real time by taking advantage of the knowledge gained as to frequently visited locations of the user.

In one configuration, mobility based location determination as described herein may pre-associate each user endpoint device with one or more geofences. For example, if a particular user endpoint device is frequently located within a pre-determined list of geofences, the method pre-associates the particular user endpoint device with the pre-determined list of geofences.

The real time processing may then be performed by first looking up the list of geofences that are pre-associated with the user endpoint device. In an example configuration, mobility based location determination as described herein may look up the list of geofences that are pre-associated with the user endpoint device using a mobile identification, e.g., an index of International Mobile Subscriber Identities (IMSIs).

Mobility based location determination as described herein may define one or more triggers for collision and one or more actions that may be taken when a trigger is triggered. For example, a trigger for a collision may be based on meeting two conditions.

For example, a collision may occur for a location that is received for the user, when the location is such that: (i) the user endpoint device is in one or more of the geofences that are pre-associated with the user endpoint device; and (ii) the location is such that the user endpoint device is in a particular bin, wherein the probabilities of being in one or more geofences are computed and stored for the particular bin, for each applicable error code.

Then, when a location is received, mobility based location determination as described herein may identify the bin (e.g., MGRS bin) for the location. A first list of geofences associated with the bin that is identified may then be obtained from storage (e.g., database, memory, etc.). Similarly, using the mobile identification, a second list of geofences that is pre-associated with the user endpoint device may be obtained from storage (e.g., database, memory, etc.). The intersection of the first geofence (e.g., taken from the list associated with the bin) and the second geofence (e.g., taken from the pre-associated list) may be determined. The method may then perform A look-up to identify the applicable probabilities in a shorter time may then be performed.

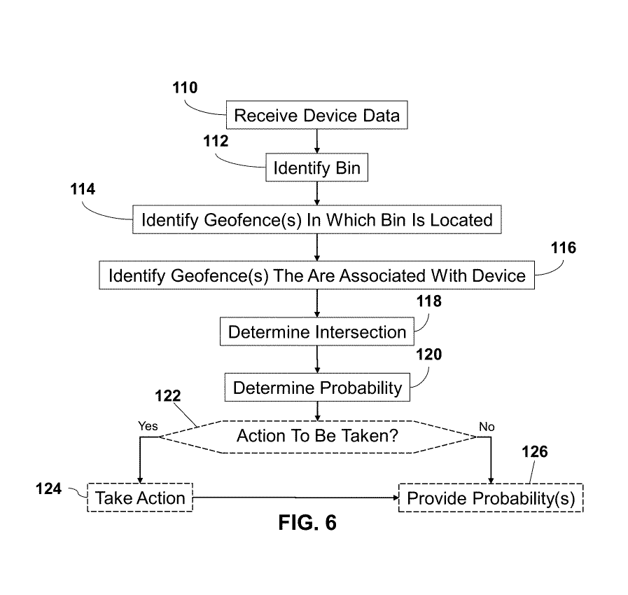

FIG. 6 is a flow diagram of an example process for providing a probabilistic determination of geofence collision. At step 110, device data may be received. Device data may comprise, for example, a mobile identification for a user endpoint device, a location record for the user endpoint device, an accuracy (error code) associated with the location record of the user endpoint device, or the like, or any appropriate combination thereof. For example, an IMSI of a cell phone, a location record (e.g., comprising a latitudinal and longitudinal coordinate of the cell phone), and an accuracy level or parameter, e.g., 200 meters, or the like, or any appropriate combination thereof, may be received.

At step 112, a specific bin in a database or the like, may be identified using the location record that is received for the user endpoint device, e.g., the latitudinal and longitudinal coordinate received for the user endpoint device.

At step 114, one or more geofences in which the bin is located may be identified using the bin that is identified as an index. For example, any number of geofences in which the particular bin is located may be looked up in a database, memory, or the like. For the example described above, mobility based location determination as described herein may identify the first geofence encompassing the business location, the second geofence encompassing the neighborhood, the third geofence encompassing the township, the fourth geofence encompassing a state, and the fifth geofence encompassing a country and so on. Since the bin is in the first through the fifth geofences, the user endpoint device from which the location is received is also in the first through the fifth geofences.

At step 116, one or more geofences that are pre-associated with the user endpoint device may be identified using the mobile identification. For example, mobility based location determination as described herein may determine the first geofence is pre-associated with the user endpoint device.

At step 118, an intersection of the one or more geofences that are identified as being pre-associated with the user endpoint device and the one or more geofences that are identified as being geofences in which the bin is located may be determined. For the example described above, the first geofence may identified as being the only geofence that is an element of an intersection of the geofences that are associated with the user endpoint device, and the geofences in which the bin is located.

At step 120, for each particular geofence in the intersection that is determined, a probability of being in the particular geofence may be determined, wherein the probability of being in the particular geofence may be determined in accordance with the accuracy level associated with the location record of the user endpoint device. The determining of the probabilities may be performed by looking up in a database, memory, or the like, populated by computing the probabilities as described above. For the example described above, the process may determine the probability of being in the first geofence for the accuracy of 200 meters.

At optional step 122, it may be determined if there is an action to be taken. For example, operations personnel may be notified if the probability of being in the geofence is below a threshold. If there is no action to be taken, the process may proceed to step 126. Otherwise, the process may proceed to step 124.

At optional step 124, an action may be taken or recommended to be taken. For example, operations personnel may be notified to take a particular action. Responsive to the notification, operations personnel may initiate certain operations, maintenance, provisioning, network upgrade functions. From step 124 the process may proceed to step 126.

At optional step 126, the probability, or probabilities, may be provider to a user. For example, the service provider may have users, e.g., network operations staff, responsible for ascertaining the reliability of a determination of a location of a customer, e.g., a customer accessing services via the user endpoint point device for which the location is being determined and the geofence in which the user endpoint device is located is being ascertained. In an example configuration, the probabilities also may be provided directly to the customer. From step 126, the process may proceed to step 110 to continue receiving location records of user endpoint devices.

In at example configuration, the determined probabilities may be used to determine confidence intervals regarding a specific location. For example, a service provider may communicate with a customer and provide a confidence interval indicating how certain the location determination is, when the service provider claims that the customer's user endpoint device is located at a particular latitudinal and longitudinal coordinate. For example, the service provider may assert that the location is accurate with 95% certainty that the user is currently within a particular geofence. This granularity of probability information (confidence information) is may be more useful to the user instead of simply declaring to the user that he or she is within a particular geofence. As the user approaches the edge of the geofence, the user may be provided with an ever decreasing level of confidence, thereby alerting the user that he or she is approaching the edge of the geofence.

In an example configuration, the confidence intervals may be used to provide different levels of service to a customer. For example, when the confidence level is high, a higher priced service may be offered to the customer. If the confidence level is below a predetermined threshold, the service provider may offer only a lower priced service. Thus, the location service can be priced in a manner that is based on how accurate the location information will be.

Although mobility based location determination is described for a scenario in which a user endpoint device is located in a bin, wherein the bin may be located in any number of geofences, mobility based location determination as described herein may be used for other applications. For example, the geofences may be expanded to include other attributes. This extension may be presented in terms of a geo-object, rather than a geofence. For example, a geo-object may comprise one or more of a geofence, one or more pre-defined triggers, one or more pre-defined actions to be taken when a trigger condition is satisfied, a set of objects to which the geo-object applies, or the like, or any appropriate combination thereof.

Moreover, mobility based location determination as described herein may be independent of a shape of a geofence. For example, a geofence may be defined with missing areas in the middle. For instance, if a user endpoint device cannot be located within a particular area located within the boundary of the geofence, the particular area may simply be ignored by not computing the probability for the particular area. Hence, complex polygons may be defined and the probabilities may be computed at the same speed as those of the rectangular shaped geofences. In addition, the lookup process may be the same, regardless of how many geofences are defined.

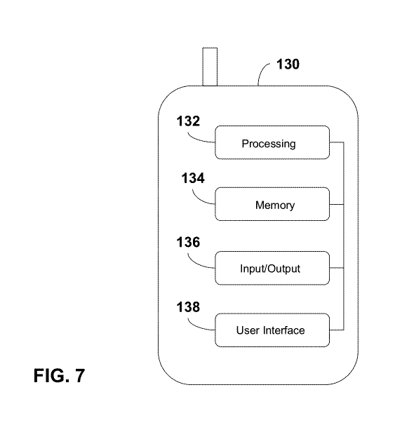

FIG. 7 is a block diagram of an example device 130 that may be utilized with mobility based location determination, as described herein. The device 130 may comprise and/or be incorporated into any appropriate device, examples of which may include a mobile device, a mobile communications device, an end user device, a cellular phone, a portable computing device, such as a laptop, a personal digital assistant (“PDA”), a portable phone (e.g., a cell phone or the like, a smart phone, a video phone), a portable email device, a portable gaming device, a TV, a DVD player, portable media player, (e.g., a portable music player, such as an MP3 player, a Walkman, etc.), a portable navigation device (e.g., GPS compatible device, A-GPS compatible device, etc.), or a combination thereof. The device 130 may include devices that are not typically thought of as portable, such as, for example, a public computing device, a navigation device installed in-vehicle, a set top box, or the like. The mobile device 130 can include non-conventional computing devices, such as, for example, a kitchen appliance, a motor vehicle control (e.g., steering wheel), etc., or the like. As evident from the herein description, the device depicted in FIG. 7 in not to be construed as software per se. Moreover, as described herein, a user equipment, a UE, a device, a communications device, an end user device, or a mobile device is not to be construed as software per se.

The device 130 may comprise any appropriate device, mechanism, software, and/or hardware for effectuating mobility based location determination, as described herein.

In an example embodiment, the device 130 may comprise a processor and memory coupled to the processor. The memory may comprise executable instructions that when executed by the processor cause the processor to effectuate operations associated with mobility based location determination, as described herein.

In an example configuration, the device 130 may comprise a processing portion 132, a memory portion 134, an input/output portion 136, and a user interface (UI) portion 138. Each portion of the device 130 may comprise circuitry for performing functions associated with each respective portion. Thus, each portion may comprise hardware, or a combination of hardware and software. Accordingly, each portion of the device 130 is not to be construed as software per se. It is emphasized that the block diagram depiction of device 130 is exemplary and not intended to imply a specific implementation and/or configuration. For example, in an example configuration, the device 130 may comprise a cellular communications technology and the processing portion 132 and/or the memory portion 134 may be implemented, in part or in total, on a subscriber identity module (SIM) of the device 130. In another example configuration, the device 130 may comprise a laptop computer. The laptop computer may include a SIM, and various portions of the processing portion 132 and/or the memory portion 134 may be implemented on the SIM, on the laptop other than the SIM, or any combination thereof.

The processing portion 132, memory portion 134, and input/output portion 136 may be coupled together to allow communications therebetween. In various embodiments, the input/output portion 136 may comprise a receiver of the device 130, a transmitter of the device 130, or a combination thereof. The input/output portion 136 may be capable of receiving and/or providing information pertaining to mobility based location determination, as described herein. In various configurations, the input/output portion 136 may receive and/or provide information via any appropriate means, such as, for example, optical means (e.g., infrared), electromagnetic means (e.g., RF, WI-FI, BLUETOOTH, ZIGBEE, etc.), acoustic means (e.g., speaker, microphone, ultrasonic receiver, ultrasonic transmitter), or a combination thereof.

The processing portion 132 may be capable of performing functions pertaining to mobility based location determination, as described herein. In a basic configuration, the device 130 may include at least one memory portion 134. The memory portion 134 may comprise a storage medium having a concrete, tangible, physical structure. As is known, a signal does not have a concrete, tangible, physical structure. The memory portion 134, as well as any computer-readable storage medium described herein, is not to be construed as a signal. The memory portion 134, as well as any computer-readable storage medium described herein, is not to be construed as a transient signal. Further, the memory portion 134, as well as any computer-readable storage medium described herein, is not to be construed as a propagating signal. The memory portion 134, as well as any computer-readable storage medium described herein, is to be construed as an article of manufacture having a concrete, tangible, physical structure.

The memory portion 134 may store any information utilized in conjunction with mobility based location determination, as described herein. Depending upon the exact configuration and type of processor, the memory portion 134 may be volatile (such as some types of RAM), non-volatile (such as ROM, flash memory, etc.), or a combination thereof. The mobile device 130 may include additional storage (e.g., removable storage and/or non-removable storage) including, but not limited to, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or any other medium which can be used to store information and which can be accessed by the mobile device 130.

The device 130 also may contain a user interface (UI) portion 138 allowing a user to communicate with the device 130. The UI portion 138 may be capable of rendering any information utilized in conjunction with mobility based location determination, as described herein. The UI portion 138 may provide the ability to control the device 130, via, for example, buttons, soft keys, voice actuated controls, a touch screen, movement of the mobile device 130, visual cues (e.g., moving a hand in front of a camera on the mobile device 130), or the like. The UI portion 138 may provide visual information (e.g., via a display), audio information (e.g., via speaker), mechanically (e.g., via a vibrating mechanism), or a combination thereof. In various configurations, the UI portion 138 may comprise a display, a touch screen, a keyboard, an accelerometer, a motion detector, a speaker, a microphone, a camera, a tilt sensor, or any combination thereof. The UI portion 138 may comprise means for inputting biometric information, such as, for example, fingerprint information, retinal information, voice information, and/or facial characteristic information.

The UI portion 138 may include a display for displaying multimedia such as, for example, application graphical user interfaces (GUIs), text, images, video, telephony functions such as Caller ID data, setup functions, menus, music, metadata, messages, wallpaper, graphics, Internet content, device status, preferences settings, map and location data, routes and other directions, points of interest (POI), and the like.

In some embodiments, the UI portion may comprise a user interface (UI) application. The UI application may interface with a client or operating system (OS) to, for example, facilitate user interaction with device functionality and data. The UI application may aid a user to facilitate mobility based location determination, as described herein. The UI application may aid a user in entering message content, viewing received messages, answering/initiating calls, entering/deleting data, entering and setting user IDs and passwords, configuring settings, manipulating content and/or settings, interacting with other applications, or the like, and may aid the user in inputting selections associated with discovering, negotiating, sharing, and/or exchanging information and/or capabilities.

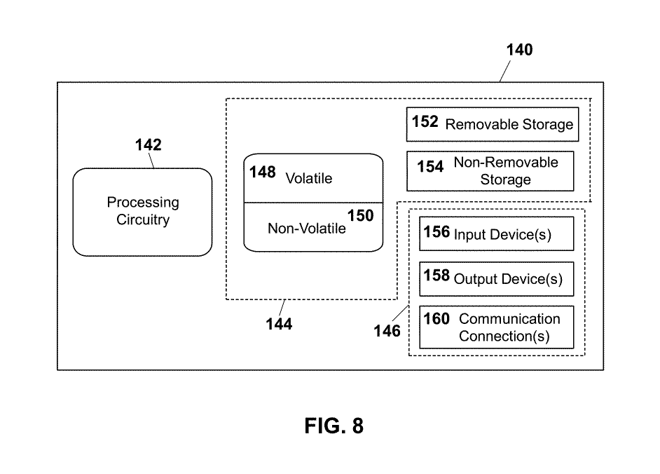

FIG. 8 is a block diagram of network entity of a communication network which may be utilized in conjunction with mobility based location determination as described herein. The network entity 140 may comprise hardware or a combination of hardware and software. In an example embodiment, the functionality to facilitate mobility based location determination, as described herein, may reside in any one or combination of network entities. The network entity 140 depicted in FIG. 8 may represent and perform functionality of any appropriate network entity, or combination of network entities, such as, for example, a component or various components of a cellular broadcast system wireless network, a processor, a server, a gateway, a node, a MSC, a SMSC, an ALFS, a GMLC, a RAN, a SMLC, or the like, or any appropriate combination thereof. It is emphasized that the block diagram depicted in FIG. 8 is exemplary and not intended to imply a specific implementation or configuration. Thus, the network entity 140 may be implemented in a single device or multiple devices (e.g., single server or multiple servers, single gateway or multiple gateways, single controller or multiple controllers, etc.). Multiple network entities may be distributed or centrally located. Multiple network entities may communicate wirelessly, via hard wire, or any appropriate combination thereof.

In an example embodiment, the network entity 140 may comprise a processor and memory coupled to the processor. The memory may comprise executable instructions that when executed by the processor cause the processor to effectuate operations associated with mobility based location determination, as described herein. As evident from the herein description, the network entity 140 is not to be construed as software per se.

In an example configuration, the network entity 140 may comprise a processing portion 142, a memory portion 144, and an input/output portion 146. The processing portion 142, memory portion 144, and input/output portion 146 may be coupled together (coupling not shown in FIG. 8) to allow communications therebetween. Each portion of the network entity 140 may comprise circuitry for performing functions associated with each respective portion. Thus, each portion may comprise hardware, or a combination of hardware and software. Accordingly, each portion of the network entity 140 is not to be construed as software per se. The input/output portion 146 may be capable of receiving and/or providing information from/to a communications device and/or other network entities configured for mobility based location determination, as described herein. For example, the input/output portion 146 may include a wireless communications (e.g., 2.5G/3G/4G/5G/GPS) card. The input/output portion 146 may be capable of receiving and/or sending video information, audio information, control information, image information, data, or any combination thereof. In an example embodiment, the input/output portion 146 may be capable of receiving and/or sending information to determine a location of the network entity 140 and/or the communications network entity 140. In an example configuration, the input\output portion 146 may comprise a GPS receiver. In an example configuration, the network entity 140 may determine its own geographical location and/or the geographical location of a communications device through any type of location determination system including, for example, the Global Positioning System (GPS), assisted GPS (A-GPS), time difference of arrival calculations, configured constant location (in the case of non-moving devices), any combination thereof, or any other appropriate means. In various configurations, the input/output portion 146 may receive and/or provide information via any appropriate means, such as, for example, optical means (e.g., infrared), electromagnetic means (e.g., RF, WI-FI, BLUETOOTH, ZIGBEE, etc.), acoustic means (e.g., speaker, microphone, ultrasonic receiver, ultrasonic transmitter), or a combination thereof. In an example configuration, the input/output portion may comprise a WIFI finder, a two way GPS chipset or equivalent, or the like, or a combination thereof.

The processing portion 142 may be capable of performing functions associated with mobility based location determination, as described herein. For example, the processing portion 142 may be capable of, in conjunction with any other portion of the network entity 140, installing an application for mobility based location determination, as described herein.

In a basic configuration, the network entity 140 may include at least one memory portion 144. The memory portion 144 may comprise a storage medium having a concrete, tangible, physical structure. As is known, a signal does not have a concrete, tangible, physical structure. The memory portion 144, as well as any computer-readable storage medium described herein, is not to be construed as a signal. The memory portion 144, as well as any computer-readable storage medium described herein, is not to be construed as a transient signal. The memory portion 144, as well as any computer-readable storage medium described herein, is not to be construed as a propagating signal. The memory portion 144, as well as any computer-readable storage medium described herein, is to be construed as an article of manufacture having a concrete, tangible, physical structure.

The memory portion 144 may store any information utilized in conjunction with mobility based location determination, as described herein. Depending upon the exact configuration and type of processor, the memory portion 144 may be volatile 148 (such as some types of RAM), non-volatile 150 (such as ROM, flash memory, etc.), or a combination thereof. The network entity 140 may include additional storage (e.g., removable storage 152 and/or non-removable storage 154) including, for example, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or any other medium which can be used to store information and which can be accessed by the network entity 140.

The network entity 140 also may contain communications connection(s) 160 that allow the network entity 140 to communicate with other devices, network entities, or the like. A communications connection(s) may comprise communication media. Communication media typically embody computer readable instructions, data structures, program modules or other data in a modulated data signal such as a carrier wave or other transport mechanism and includes any information delivery media. By way of example, and not limitation, communication media may include wired media such as a wired network or direct-wired connection, and wireless media such as acoustic, RF, infrared, and other wireless media. The term computer readable media as used herein includes both storage media and communication media. The network entity 140 also may include input device(s) 156 such as keyboard, mouse, pen, voice input device, touch input device, etc. Output device(s) 158 such as a display, speakers, printer, etc. also may be included.

Mobility based location determination may be utilized in conjunction with various telecommunications networks. Some of which are described below.

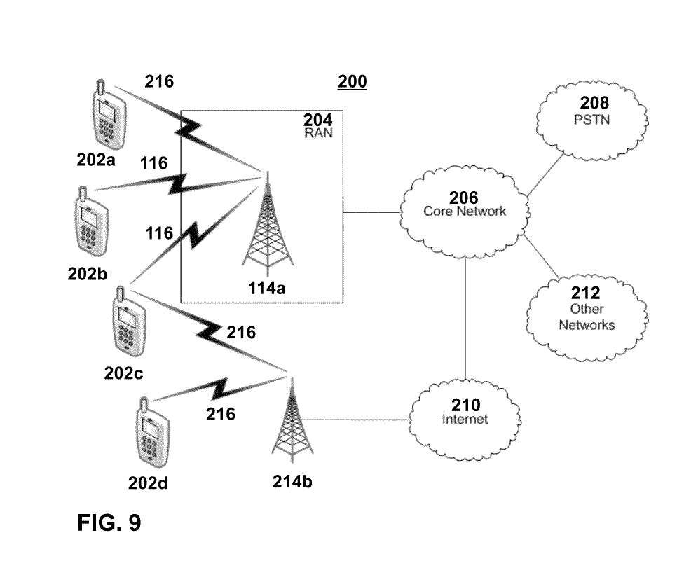

FIG. 9 is a diagram of an example communications system that may be utilized to effectuate mobility based location determination, as described herein. The communications system 200 may be a multiple access system that provides content, such as voice, data, video, messaging, broadcast, etc., to multiple wireless users. The communications system 200 may enable multiple wireless users to access such content through the sharing of system resources, including wireless bandwidth. For example, the communications systems 200 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. A communications system such as that shown in FIG. 9 may also be referred to herein as a network.

As shown in FIG. 9, the communications system 200 may include wireless transmit/receive units (WTRUs) 202a, 202b, 202c, 202d, a radio access network (RAN) 204, a core network 206, a public switched telephone network (PSTN) 208, the Internet 210, and other networks 212, though it will be appreciated that the disclosed embodiments contemplate any number of WTRUs, base stations, networks, and/or network elements. Each of the WTRUs 202a, 202b, 202c, 202d may be any type of device configured to operate and/or communicate in a wireless environment. For example, a WTRU may comprise network entity 140, device 130, a UE, or the like, or any combination thereof. By way of example, the WTRUs 202a, 202b, 202c, 202d may be configured to transmit and/or receive wireless signals and may include user equipment (UE), a mobile station, a mobile device, a fixed or mobile subscriber unit, a pager, a cellular telephone, a personal digital assistant (PDA), a smartphone, a laptop, a netbook, a personal computer, a wireless sensor, consumer electronics, and the like.

The communications systems 200 may also include a base station 214a and a base station 214b. Each of the base stations 214a, 214b may be any type of device configured to wirelessly interface with at least one of the WTRUs 202a, 202b, 202c, 202d to facilitate access to one or more communication networks, such as the core network 206, the Internet 210, and/or the networks 212. By way of example, the base stations 214a, 214b may be a base transceiver station (BTS), a Node-B, an eNode B, a Home Node B, a Home eNode B, a site controller, an access point (AP), a wireless router, and the like. While the base stations 214a, 214b are each depicted as a single element, it will be appreciated that the base stations 214a, 214b may include any number of interconnected base stations and/or network elements.

The base station 214a may be part of the RAN 204, which may also include other base stations and/or network elements (not shown), such as a base station controller (BSC), a radio network controller (RNC), relay nodes, etc. The base station 214a and/or the base station 214b may be configured to transmit and/or receive wireless signals within a particular geographic region, which may be referred to as a cell (not shown). The cell may further be divided into cell sectors. For example, the cell associated with the base station 214a may be divided into three sectors. Thus, in an embodiment, the base station 214a may include three transceivers, i.e., one for each sector of the cell. In another embodiment, the base station 214a may employ multiple-input multiple output (MIMO) technology and, therefore, may utilize multiple transceivers for each sector of the cell.

The base stations 214a, 214b may communicate with one or more of the WTRUs 202a, 202b, 202c, 202d over an air interface 216, which may be any suitable wireless communication link (e.g., radio frequency (RF), microwave, infrared (IR), ultraviolet (UV), visible light, etc.). The air interface 216 may be established using any suitable radio access technology (RAT).

More specifically, as noted above, the communications system 200 may be a multiple access system and may employ one or more channel access schemes, such as CDMA, TDMA, FDMA, OFDMA, SC-FDMA, and the like. For example, the base station 214a in the RAN 204 and the WTRUs 202a, 202b, 202c may implement a radio technology such as Universal Mobile Telecommunications System (UMTS) Terrestrial Radio Access (UTRA) that may establish the air interface 216 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 214a and the WTRUs 202a, 202b, 202c may implement a radio technology such as Evolved UMTS Terrestrial Radio Access (E-UTRA), which may establish the air interface 216 using Long Term Evolution (LTE) and/or LTE-Advanced (LTE-A).

In other embodiments, the base station 214a and the WTRUs 202a, 202b, 202c may implement radio technologies such as IEEE 802.16 (i.e., Worldwide Interoperability for Microwave Access (WiMAX)), CDMA2000, CDMA2000 2×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 214b in FIG. 9 may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 214b and the WTRUs 202c, 202d may implement a radio technology such as IEEE 802.11 to establish a wireless local area network (WLAN). In another embodiment, the base station 214b and the WTRUs 202c, 202d may implement a radio technology such as IEEE 802.15 to establish a wireless personal area network (WPAN). In yet another embodiment, the base station 214b and the WTRUs 202c, 202d may utilize a cellular-based RAT (e.g., WCDMA, CDMA2000, GSM, LTE, LTE-A, etc.) to establish a picocell or femtocell. As shown in FIG. 9, the base station 214b may have a direct connection to the Internet 210. Thus, the base station 214b may not be required to access the Internet 210 via the core network 206.

The RAN 204 may be in communication with the core network 206, which may be any type of network configured to provide voice, data, applications, and/or voice over internet protocol (VoIP) services to one or more of the WTRUs 202a, 202b, 202c, 202d. For example, the core network 206 may provide call control, billing services, mobile location-based services, pre-paid calling, Internet connectivity, video distribution, etc., and/or perform high-level security functions, such as user authentication. Although not shown in FIG. 9, it will be appreciated that the RAN 204 and/or the core network 206 may be in direct or indirect communication with other RANs that employ the same RAT as the RAN 204 or a different RAT. For example, in addition to being connected to the RAN 204, which may be utilizing an E-UTRA radio technology, the core network 206 may also be in communication with another RAN (not shown) employing a GSM radio technology.

The core network 206 may also serve as a gateway for the WTRUs 202a, 202b, 202c, 202d to access the PSTN 208, the Internet 210, and/or other networks 212. The PSTN 208 may include circuit-switched telephone networks that provide plain old telephone service (POTS). The Internet 210 may include a global system of interconnected computer networks and devices that use common communication protocols, such as the transmission control protocol (TCP), user datagram protocol (UDP) and the internet protocol (IP) in the TCP/IP internet protocol suite. The networks 212 may include wired or wireless communications networks owned and/or operated by other service providers. For example, the networks 212 may include another core network connected to one or more RANs, which may employ the same RAT as the RAN 204 or a different RAT.

Some or all of the WTRUs 202a, 202b, 202c, 202d in the communications system 200 may include multi-mode capabilities, i.e., the WTRUs 202a, 202b, 202c, 202d may include multiple transceivers for communicating with different wireless networks over different wireless links. For example, the WTRU 202c shown in FIG. 9 may be configured to communicate with the base station 214a, which may employ a cellular-based radio technology, and with the base station 214b, which may employ an IEEE 802 radio technology.

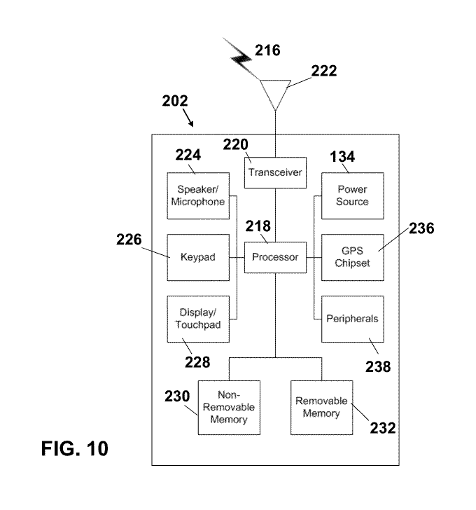

FIG. 10 is a system diagram of an example WTRU 202 which may be utilized to facilitate mobility based location determination, as described herein. As shown in FIG. 10, the WTRU 202 may include a processor 218, a transceiver 220, a transmit/receive element 222, a speaker/microphone 224, a keypad 226, a display/touchpad 228, non-removable memory 230, removable memory 232, a power source 234, a global positioning system (GPS) chipset 236, and other peripherals 238. It will be appreciated that the WTRU 202 may include any sub-combination of the foregoing elements while remaining consistent with an embodiment.

The processor 218 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 218 may perform signal coding, data processing, power control, input/output processing, and/or any other functionality that enables the WTRU 202 to operate in a wireless environment. The processor 218 may be coupled to the transceiver 220, which may be coupled to the transmit/receive element 222. While FIG. 10 depicts the processor 218 and the transceiver 220 as separate components, it will be appreciated that the processor 218 and the transceiver 220 may be integrated together in an electronic package or chip.

The transmit/receive element 222 may be configured to transmit signals to, or receive signals from, a base station (e.g., the base station 214a) over the air interface 216. For example, in one embodiment, the transmit/receive element 222 may be an antenna configured to transmit and/or receive RF signals. In another embodiment, the transmit/receive element 222 may be an emitter/detector configured to transmit and/or receive IR, UV, or visible light signals, for example. In yet another embodiment, the transmit/receive element 222 may be configured to transmit and receive both RF and light signals. It will be appreciated that the transmit/receive element 222 may be configured to transmit and/or receive any combination of wireless signals.

In addition, although the transmit/receive element 222 is depicted in FIG. 10 as a single element, the WTRU 202 may include any number of transmit/receive elements 222. More specifically, the WTRU 202 may employ MIMO technology. Thus, in one embodiment, the WTRU 202 may include two or more transmit/receive elements 222 (e.g., multiple antennas) for transmitting and receiving wireless signals over the air interface 216.

The transceiver 220 may be configured to modulate the signals that are to be transmitted by the transmit/receive element 222 and to demodulate the signals that are received by the transmit/receive element 222. As noted above, the WTRU 202 may have multi-mode capabilities. Thus, the transceiver 220 may include multiple transceivers for enabling the WTRU 202 to communicate via multiple RATs, such as UTRA and IEEE 802.11, for example.

The processor 218 of the WTRU 202 may be coupled to, and may receive user input data from, the speaker/microphone 224, the keypad 226, and/or the display/touchpad 228 (e.g., a liquid crystal display (LCD) display unit or organic light-emitting diode (OLED) display unit). The processor 218 may also output user data to the speaker/microphone 224, the keypad 226, and/or the display/touchpad 228. In addition, the processor 218 may access information from, and store data in, any type of suitable memory, such as the non-removable memory 230 and/or the removable memory 232. The non-removable memory 230 may include random-access memory (RAM), read-only memory (ROM), a hard disk, or any other type of memory storage device. The removable memory 232 may include a subscriber identity module (SIM) card, a memory stick, a secure digital (SD) memory card, and the like. In other embodiments, the processor 218 may access information from, and store data in, memory that is not physically located on the WTRU 202, such as on a server or a home computer (not shown).

The processor 218 may receive power from the power source 234, and may be configured to distribute and/or control the power to the other components in the WTRU 202. The power source 234 may be any suitable device for powering the WTRU 202. For example, the power source 234 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 218 may also be coupled to the GPS chipset 236, which may be configured to provide location information (e.g., longitude and latitude) regarding the current location of the WTRU 202. In addition to, or in lieu of, the information from the GPS chipset 236, the WTRU 202 may receive location information over the air interface 216 from a base station (e.g., base stations 214a, 214b) and/or determine its location based on the timing of the signals being received from two or more nearby base stations. It will be appreciated that the WTRU 202 may acquire location information by way of any suitable location-determination method while remaining consistent with an embodiment.

The processor 218 may further be coupled to other peripherals 238, which may include one or more software and/or hardware modules that provide additional features, functionality and/or wired or wireless connectivity. For example, the peripherals 238 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

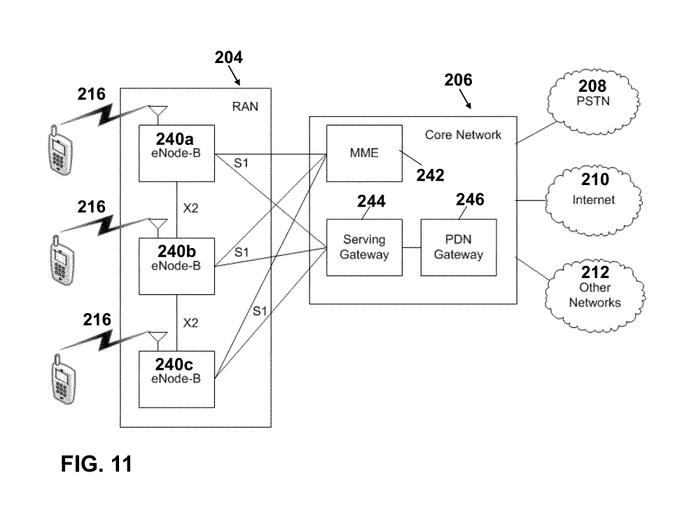

FIG. 11 is an example system diagram of RAN 204 and a core network 206 that may be utilized to effectuate mobility based location determination, as described herein. As noted above, the RAN 204 may employ an E-UTRA radio technology to communicate with the WTRUs 202a, 202b, and 202c over the air interface 216. The RAN 204 may also be in communication with the core network 206.

The RAN 204 may include eNode-Bs 240a, 240b, 240c, though it will be appreciated that the RAN 204 may include any number of eNode-Bs while remaining consistent with an embodiment. The eNode-Bs 240a, 240b, 240c may each include one or more transceivers for communicating with the WTRUs 202a, 202b, 202c over the air interface 216. In one embodiment, the eNode-Bs 240a, 240b, 240c may implement MIMO technology. Thus, the eNode-B 240a, for example, may use multiple antennas to transmit wireless signals to, and receive wireless signals from, the WTRU 202a.

Each of the eNode-Bs 240a, 240b, and 240c may be associated with a particular cell (not shown) and may be configured to handle radio resource management decisions, handover decisions, scheduling of users in the uplink and/or downlink, and the like. As shown in FIG. 11, the eNode-Bs 240a, 240b, 240c may communicate with one another over an X2 interface.

The core network 206 shown in FIG. 11 may include a mobility management gateway or entity (MME) 242, a serving gateway 244, and a packet data network (PDN) gateway 246. While each of the foregoing elements are depicted as part of the core network 206, it will be appreciated that any one of these elements may be owned and/or operated by an entity other than the core network operator.

The MME 242 may be connected to each of the eNode-Bs 240a, 240b, 240c in the RAN 204 via an S1 interface and may serve as a control node. For example, the MME 242 may be responsible for authenticating users of the WTRUs 202a, 202b, 202c, bearer activation/deactivation, selecting a particular serving gateway during an initial attach of the WTRUs 202a, 202b, 202c, and the like. The MME 242 may also provide a control plane function for switching between the RAN 204 and other RANs (not shown) that employ other radio technologies, such as GSM or WCDMA.

The serving gateway 244 may be connected to each of the eNode-Bs 240a, 240b, and 240c in the RAN 204 via the S1 interface. The serving gateway 244 may generally route and forward user data packets to/from the WTRUs 202a, 202b, 202c. The serving gateway 244 may also perform other functions, such as anchoring user planes during inter-eNode B handovers, triggering paging when downlink data is available for the WTRUs 202a, 202b, 202c, managing and storing contexts of the WTRUs 202a, 202b, 202c, and the like.

The serving gateway 244 may also be connected to the PDN gateway 246, which may provide the WTRUs 202a, 202b, 202c with access to packet-switched networks, such as the Internet 210, to facilitate communications between the WTRUs 202a, 202b, 202c and IP-enabled devices.

The core network 206 may facilitate communications with other networks. For example, the core network 206 may provide the WTRUs 202a, 202b, 202c with access to circuit-switched networks, such as the PSTN 208, to facilitate communications between the WTRUs 202a, 202b, 202c and traditional land-line communications devices. For example, the core network 206 may include, or may communicate with, an IP gateway (e.g., an IP multimedia subsystem (IMS) server) that serves as an interface between the core network 206 and the PSTN 208. In addition, the core network 206 may provide the WTRUs 202a, 202b, 202c with access to the networks 212, which may include other wired or wireless networks that are owned and/or operated by other service providers.

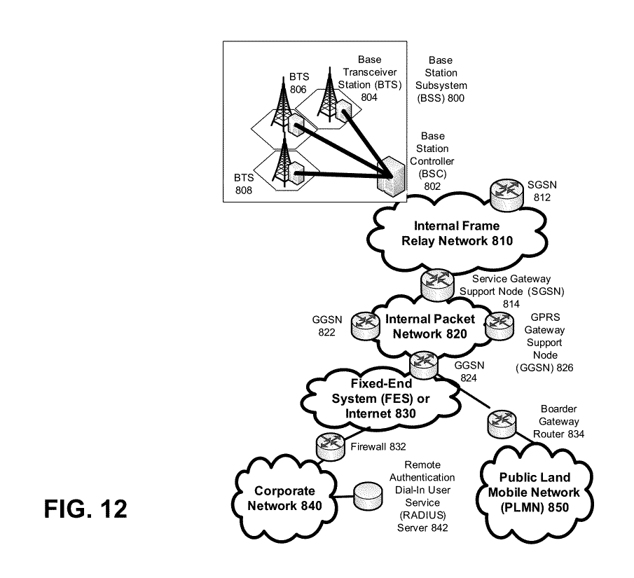

FIG. 12 depicts an overall block diagram of an example packet-based mobile cellular network environment, such as a GPRS network, that may be utilized to effectuate mobility based location determination, as described herein. In the example packet-based mobile cellular network environment shown in FIG. 12, there are a plurality of Base Station Subsystems (“BSS”) 800 (only one is shown), each of which comprises a Base Station Controller (“BSC”) 802 serving a plurality of Base Transceiver Stations (“BTS”) such as BTSs 804, 806, and 808. BTSs 804, 806, 808, etc. are the access points where users of packet-based mobile devices become connected to the wireless network. In example fashion, the packet traffic originating from user devices is transported via an over-the-air interface to a BTS 808, and from the BTS 808 to the BSC 802. Base station subsystems, such as BSS 800, are a part of internal frame relay network 810 that can include Service GPRS Support Nodes (“SGSN”) such as SGSN 812 and 814. Each SGSN is connected to an internal packet network 820 through which a SGSN 812, 814, etc. can route data packets to and from a plurality of gateway GPRS support nodes (GGSN) 822, 824, 826, etc. As illustrated, SGSN 814 and GGSNs 822, 824, and 826 are part of internal packet network 820. Gateway GPRS serving nodes 822, 824 and 826 mainly provide an interface to external Internet Protocol (“IP”) networks such as Public Land Mobile Network (“PLMN”) 850, corporate intranets 840, or Fixed-End System (“FES”) or the public Internet 830. As illustrated, subscriber corporate network 840 may be connected to GGSN 824 via firewall 832; and PLMN 850 is connected to GGSN 824 via boarder gateway router 834. The Remote Authentication Dial-In User Service (“RADIUS”) server 842 may be used for caller authentication when a user of a mobile cellular device calls corporate network 840.

Generally, there may be a several cell sizes in a GSM network, referred to as macro, micro, pico, femto and umbrella cells. The coverage area of each cell is different in different environments. Macro cells can be regarded as cells in which the base station antenna is installed in a mast or a building above average roof top level. Micro cells are cells whose antenna height is under average roof top level. Micro-cells are typically used in urban areas. Pico cells are small cells having a diameter of a few dozen meters. Pico cells are used mainly indoors. Femto cells have the same size as pico cells, but a smaller transport capacity. Femto cells are used indoors, in residential, or small business environments. On the other hand, umbrella cells are used to cover shadowed regions of smaller cells and fill in gaps in coverage between those cells.

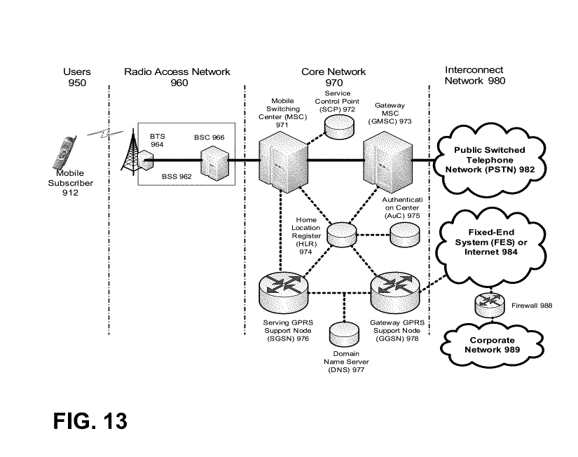

FIG. 13 illustrates an architecture of a typical GPRS network that may be utilized to effectuate mobility based location determination, as described herein. The architecture depicted in FIG. 13 may be segmented into four groups: users 950, radio access network 960, core network 970, and interconnect network 980. Users 950 comprise a plurality of end users. Note, device 912 is referred to as a mobile subscriber in the description of network shown in FIG. 13. In an example embodiment, the device depicted as mobile subscriber 912 comprises a communications device (e.g., communications device 130). Radio access network 960 comprises a plurality of base station subsystems such as BSSs 962, which include BTSs 964 and BSCs 966. Core network 970 comprises a host of various network elements. As illustrated in FIG. 13, core network 970 may comprise Mobile Switching Center (“MSC”) 971, Service Control Point (“SCP”) 972, gateway MSC 973, SGSN 976, Home Location Register (“HLR”) 974, Authentication Center (“AuC”) 975, Domain Name Server (“DNS”) 977, and GGSN 978. Interconnect network 980 also comprises a host of various networks and other network elements. As illustrated in FIG. 13, interconnect network 980 comprises Public Switched Telephone Network (“PSTN”) 982, Fixed-End System (“FES”) or Internet 984, firewall 988, and Corporate Network 989.

A mobile switching center can be connected to a large number of base station controllers. At MSC 971, for instance, depending on the type of traffic, the traffic may be separated in that voice may be sent to Public Switched Telephone Network (“PSTN”) 982 through Gateway MSC (“GMSC”) 973, and/or data may be sent to SGSN 976, which then sends the data traffic to GGSN 978 for further forwarding.

When MSC 971 receives call traffic, for example, from BSC 966, it sends a query to a database hosted by SCP 972. The SCP 972 processes the request and issues a response to MSC 971 so that it may continue call processing as appropriate.

The HLR 974 is a centralized database for users to register to the GPRS network. HLR 974 stores static information about the subscribers such as the International Mobile Subscriber Identity (“IMSI”), subscribed services, and a key for authenticating the subscriber. HLR 974 also stores dynamic subscriber information such as the current location of the mobile subscriber. Associated with HLR 974 is AuC 975. AuC 975 is a database that contains the algorithms for authenticating subscribers and includes the associated keys for encryption to safeguard the user input for authentication.

In the following, depending on context, the term “mobile subscriber” sometimes refers to the end user and sometimes to the actual portable device, such as a mobile device, used by an end user of the mobile cellular service. When a mobile subscriber turns on his or her mobile device, the mobile device goes through an attach process by which the mobile device attaches to an SGSN of the GPRS network. In FIG. 13, when mobile subscriber 912 initiates the attach process by turning on the network capabilities of the mobile device, an attach request is sent by mobile subscriber 912 to SGSN 976. The SGSN 976 queries another SGSN, to which mobile subscriber 912 was attached before, for the identity of mobile subscriber 912. Upon receiving the identity of mobile subscriber 912 from the other SGSN, SGSN 976 requests more information from mobile subscriber 912. This information is used to authenticate mobile subscriber 912 to SGSN 976 by HLR 974. Once verified, SGSN 976 sends a location update to HLR 974 indicating the change of location to a new SGSN, in this case SGSN 976. HLR 974 notifies the old SGSN, to which mobile subscriber 912 was attached before, to cancel the location process for mobile subscriber 912. HLR 974 then notifies SGSN 976 that the location update has been performed. At this time, SGSN 976 sends an Attach Accept message to mobile subscriber 912, which in turn sends an Attach Complete message to SGSN 976.

After attaching itself with the network, mobile subscriber 912 then goes through the authentication process. In the authentication process, SGSN 976 sends the authentication information to HLR 974, which sends information back to SGSN 976 based on the user profile that was part of the user's initial setup. The SGSN 976 then sends a request for authentication and ciphering to mobile subscriber 912. The mobile subscriber 912 uses an algorithm to send the user identification (ID) and password to SGSN 976. The SGSN 976 uses the same algorithm and compares the result. If a match occurs, SGSN 976 authenticates mobile subscriber 912.

Next, the mobile subscriber 912 establishes a user session with the destination network, corporate network 989, by going through a Packet Data Protocol (“PDP”) activation process. Briefly, in the process, mobile subscriber 912 requests access to the Access Point Name (“APN”), for example, UPS.com, and SGSN 976 receives the activation request from mobile subscriber 912. SGSN 976 then initiates a Domain Name Service (“DNS”) query to learn which GGSN node has access to the UPS.com APN. The DNS query is sent to the DNS server within the core network 970, such as DNS 977, which is provisioned to map to one or more GGSN nodes in the core network 970. Based on the APN, the mapped GGSN 978 can access the requested corporate network 989. The SGSN 976 then sends to GGSN 978 a Create Packet Data Protocol (“PDP”) Context Request message that contains necessary information. The GGSN 978 sends a Create PDP Context Response message to SGSN 976, which then sends an Activate PDP Context Accept message to mobile subscriber 912.

Once activated, data packets of the call made by mobile subscriber 912 can then go through radio access network 960, core network 970, and interconnect network 980, in a particular fixed-end system or Internet 984 and firewall 988, to reach corporate network 989.

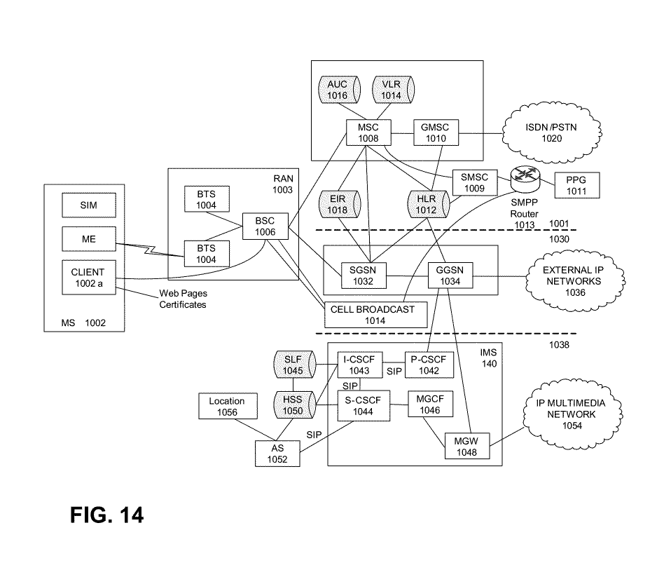

FIG. 14 illustrates an example block diagram view of a GSM/GPRS/IP multimedia network architecture that may be utilized to effectuate mobility based location determination, as described herein. As illustrated, the architecture of FIG. 14 includes a GSM core network 1001, a GPRS network 1030 and an IP multimedia network 1038. The GSM core network 1001 includes a Mobile Station (MS) 1002, at least one Base Transceiver Station (BTS) 1004 and a Base Station Controller (BSC) 1006. The MS 1002 is physical equipment or Mobile Equipment (ME), such as a mobile phone or a laptop computer that is used by mobile subscribers, with a Subscriber identity Module (SIM) or a Universal Integrated Circuit Card (UICC). The SIM or UICC includes an International Mobile Subscriber Identity (IMSI), which is a unique identifier of a subscriber. The BTS 1004 is physical equipment, such as a radio tower, that enables a radio interface to communicate with the MS. Each BTS may serve more than one MS. The BSC 1006 manages radio resources, including the BTS. The BSC may be connected to several BTSs. The BSC and BTS components, in combination, are generally referred to as a base station (BSS) or radio access network (RAN) 1003.

The GSM core network 1001 also includes a Mobile Switching Center (MSC) 1008, a Gateway Mobile Switching Center (GMSC) 1010, a Home Location Register (HLR) 1012, Visitor Location Register (VLR) 1014, an Authentication Center (AuC) 1018, and an Equipment Identity Register (EIR) 1016. The MSC 1008 performs a switching function for the network. The MSC also performs other functions, such as registration, authentication, location updating, handovers, and call routing. The GMSC 1010 provides a gateway between the GSM network and other networks, such as an Integrated Services Digital Network (ISDN) or Public Switched Telephone Networks (PSTNs) 1020. Thus, the GMSC 1010 provides interworking functionality with external networks.

The HLR 1012 is a database that contains administrative information regarding each subscriber registered in a corresponding GSM network. The HLR 1012 also contains the current location of each MS. The VLR 1014 is a database that contains selected administrative information from the HLR 1012. The VLR contains information necessary for call control and provision of subscribed services for each MS currently located in a geographical area controlled by the VLR. The HLR 1012 and the VLR 1014, together with the MSC 1008, provide the call routing and roaming capabilities of GSM. The AuC 1016 provides the parameters needed for authentication and encryption functions. Such parameters allow verification of a subscriber's identity. The EIR 1018 stores security-sensitive information about the mobile equipment.

A Short Message Service Center (SMSC) 1009 allows one-to-one Short Message Service (SMS) messages to be sent to/from the MS 1002. A Push Proxy Gateway (PPG) 1011 is used to “push” (i.e., send without a synchronous request) content to the MS 1002. The PPG 1011 acts as a proxy between wired and wireless networks to facilitate pushing of data to the MS 1002. A Short Message Peer to Peer (SMPP) protocol router 1013 is provided to convert SMS-based SMPP messages to cell broadcast messages. SMPP is a protocol for exchanging SMS messages between SMS peer entities such as short message service centers. The SMPP protocol is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. The MS 1002 sends a location update including its current location information to the MSC/VLR, via the BTS 1004 and the BSC 1006. The location information is then sent to the MS's HLR. The HLR is updated with the location information received from the MSC/VLR. The location update also is performed when the MS moves to a new location area. Typically, the location update is periodically performed to update the database as location updating events occur.

The GPRS network 1030 is logically implemented on the GSM core network architecture by introducing two packet-switching network nodes, a serving GPRS support node (SGSN) 1032, a cell broadcast and a Gateway GPRS support node (GGSN) 1034. The SGSN 1032 is at the same hierarchical level as the MSC 1008 in the GSM network. The SGSN controls the connection between the GPRS network and the MS 1002. The SGSN also keeps track of individual MS's locations and security functions and access controls.

A Cell Broadcast Center (CBC) 14 communicates cell broadcast messages that are typically delivered to multiple users in a specified area. Cell Broadcast is one-to-many geographically focused service. It enables messages to be communicated to multiple mobile phone customers who are located within a given part of its network coverage area at the time the message is broadcast.

The GGSN 1034 provides a gateway between the GPRS network and a public packet network (PDN) or other IP networks 1036. That is, the GGSN provides interworking functionality with external networks, and sets up a logical link to the MS through the SGSN. When packet-switched data leaves the GPRS network, it is transferred to an external TCP-IP network 1036, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services can be used in parallel. The MS can operate in one of three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time.

A class B MS can attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

A GPRS network 1030 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how to signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not receive pages from a circuit switched domain when engaged in a data call, since the MS is receiving data and is not listening to a paging channel. In a NOM3 network, a MS can monitor pages for a circuit switched network while received data and vice versa.

The IP multimedia network 1038 was introduced with 3GPP Release 5, and includes an IP multimedia subsystem (IMS) 1040 to provide rich multimedia services to end users. A representative set of the network entities within the IMS 1040 are a call/session control function (CSCF), a media gateway control function (MGCF) 1046, a media gateway (MGW) 1048, and a master subscriber database, called a home subscriber server (HSS) 1050. The HSS 1050 may be common to the GSM network 1001, the GPRS network 1030 as well as the IP multimedia network 1038.

The IP multimedia system 1040 is built around the call/session control function, of which there are three types: an interrogating CSCF (I-CSCF) 1043, a proxy CSCF (P-CSCF) 1042, and a serving CSCF (S-CSCF) 1044. The P-CSCF 1042 is the MS's first point of contact with the IMS 1040. The P-CSCF 1042 forwards session initiation protocol (SIP) messages received from the MS to an SIP server in a home network (and vice versa) of the MS. The P-CSCF 1042 may also modify an outgoing request according to a set of rules defined by the network operator (for example, address analysis and potential modification).

The I-CSCF 1043, forms an entrance to a home network and hides the inner topology of the home network from other networks and provides flexibility for selecting an S-CSCF. The I-CSCF 1043 may contact a subscriber location function (SLF) 1045 to determine which HSS 1050 to use for the particular subscriber, if multiple HSS's 1050 are present. The S-CSCF 1044 performs the session control services for the MS 1002. This includes routing originating sessions to external networks and routing terminating sessions to visited networks. The S-CSCF 1044 also decides whether an application server (AS) 1052 is required to receive information on an incoming SIP session request to ensure appropriate service handling. This decision is based on information received from the HSS 1050 (or other sources, such as an application server 1052). The AS 1052 also communicates to a location server 1056 (e.g., a Gateway Mobile Location Center (GMLC)) that provides a position (e.g., latitude/longitude coordinates) of the MS 1002.

The HSS 1050 contains a subscriber profile and keeps track of which core network node is currently handling the subscriber. It also supports subscriber authentication and authorization functions (AAA). In networks with more than one HSS 1050, a subscriber location function provides information on the HSS 1050 that contains the profile of a given subscriber.

The MGCF 1046 provides interworking functionality between SIP session control signaling from the IMS 1040 and ISUP/BICC call control signaling from the external GSTN networks (not shown). It also controls the media gateway (MGW) 1048 that provides user-plane interworking functionality (e.g., converting between AMR- and PCM-coded voice). The MGW 1048 also communicates with other IP multimedia networks 1054.

Push to Talk over Cellular (PoC) capable mobile phones register with the wireless network when the phones are in a predefined area (e.g., job site, etc.). When the mobile phones leave the area, they register with the network in their new location as being outside the predefined area. This registration, however, does not indicate the actual physical location of the mobile phones outside the pre-defined area.

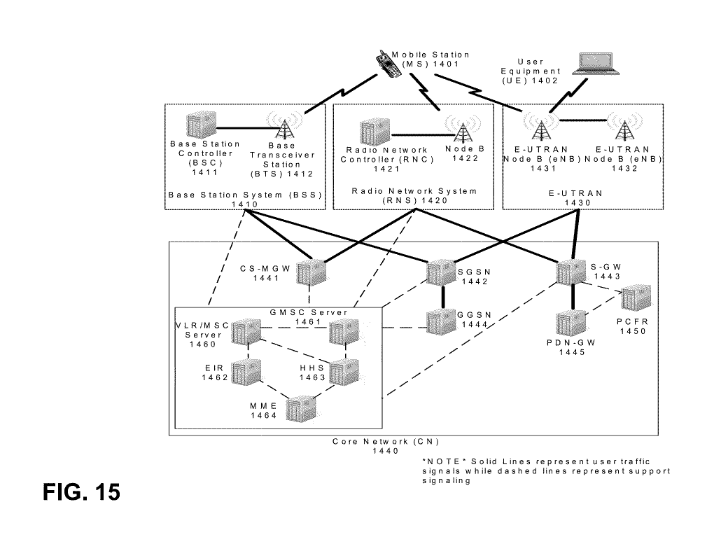

FIG. 15 illustrates a PLMN block diagram view of an example architecture that may be utilized to effectuate mobility based location determination, as described herein. Mobile Station (MS) 1401 is the physical equipment used by the PLMN subscriber. In one illustrative embodiment, communications device 200 may serve as Mobile Station 1401. Mobile Station 1401 may be one of, but not limited to, a cellular telephone, a cellular telephone in combination with another electronic device or any other wireless mobile communication device.

Mobile Station 1401 may communicate wirelessly with Base Station System (BSS) 1410. BSS 1410 contains a Base Station Controller (BSC) 1411 and a Base Transceiver Station (BTS) 1412. BSS 1410 may include a single BSC 1411/BTS 1412 pair (Base Station) or a system of BSC/BTS pairs which are part of a larger network. BSS 1410 is responsible for communicating with Mobile Station 1401 and may support one or more cells. BSS 1410 is responsible for handling cellular traffic and signaling between Mobile Station 1401 and Core Network 1440. Typically, BSS 1410 performs functions that include, but are not limited to, digital conversion of speech channels, allocation of channels to mobile devices, paging, and transmission/reception of cellular signals.

Additionally, Mobile Station 1401 may communicate wirelessly with Radio Network System (RNS) 1420. RNS 1420 contains a Radio Network Controller (RNC) 1421 and one or more Node(s) B 1422. RNS 1420 may support one or more cells. RNS 1420 may also include one or more RNC 1421/Node B 1422 pairs or alternatively a single RNC 1421 may manage multiple Nodes B 1422. RNS 1420 is responsible for communicating with Mobile Station 1401 in its geographically defined area. RNC 1421 is responsible for controlling the Node(s) B 1422 that are connected to it and is a control element in a UMTS radio access network. RNC 1421 performs functions such as, but not limited to, load control, packet scheduling, handover control, security functions, as well as controlling Mobile Station 1401's access to the Core Network (CN) 1440.

The evolved UMTS Terrestrial Radio Access Network (E-UTRAN) 1430 is a radio access network that provides wireless data communications for Mobile Station 1401 and User Equipment 1402. E-UTRAN 1430 provides higher data rates than traditional UMTS. It is part of the Long Term Evolution (LTE) upgrade for mobile networks and later releases meet the requirements of the International Mobile Telecommunications (IMT) Advanced and are commonly known as a 4G networks. E-UTRAN 1430 may include of series of logical network components such as E-UTRAN Node B (eNB) 1431 and E-UTRAN Node B (eNB) 1432. E-UTRAN 1430 may contain one or more eNBs. User Equipment 1402 may be any user device capable of connecting to E-UTRAN 1430 including, but not limited to, a personal computer, laptop, mobile device, wireless router, or other device capable of wireless connectivity to E-UTRAN 1430. The improved performance of the E-UTRAN 1430 relative to a typical UMTS network allows for increased bandwidth, spectral efficiency, and functionality including, but not limited to, voice, high-speed applications, large data transfer and IPTV, while still allowing for full mobility.

An example embodiment of a mobile data and communication service that may be implemented in the PLMN architecture described in FIG. 15 is the Enhanced Data rates for GSM Evolution (EDGE). EDGE is an enhancement for GPRS networks that implements an improved signal modulation scheme known as 8-PSK (Phase Shift Keying). By increasing network utilization, EDGE may achieve up to three times faster data rates as compared to a typical GPRS network. EDGE may be implemented on any GSM network capable of hosting a GPRS network, making it an ideal upgrade over GPRS since it may provide increased functionality of existing network resources. Evolved EDGE networks are becoming standardized in later releases of the radio telecommunication standards, which provide for even greater efficiency and peak data rates of up to 1 Mbit/s, while still allowing implementation on existing GPRS-capable network infrastructure.

Typically Mobile Station 1401 may communicate with any or all of BSS 1410, RNS 1420, or E-UTRAN 1430. In a illustrative system, each of BSS 1410, RNS 1420, and E-UTRAN 1430 may provide Mobile Station 1401 with access to Core Network 1440. The Core Network 1440 may include of a series of devices that route data and communications between end users. Core Network 1440 may provide network service functions to users in the Circuit Switched (CS) domain, the Packet Switched (PS) domain or both. The CS domain refers to connections in which dedicated network resources are allocated at the time of connection establishment and then released when the connection is terminated. The PS domain refers to communications and data transfers that make use of autonomous groupings of bits called packets. Each packet may be routed, manipulated, processed or handled independently of all other packets in the PS domain and does not require dedicated network resources.

The Circuit Switched—Media Gateway Function (CS-MGW) 1441 is part of Core Network 1440, and interacts with Visitor Location Register (VLR) and Mobile-Services Switching Center (MSC) Server 1460 and Gateway MSC Server 1461 in order to facilitate Core Network 1440 resource control in the CS domain. Functions of CS-MGW 1441 include, but are not limited to, media conversion, bearer control, payload processing and other mobile network processing such as handover or anchoring. CS-MGW 1440 may receive connections to Mobile Station 1401 through BSS 1410, RNS 1420 or both.

Serving GPRS Support Node (SGSN) 1442 stores subscriber data regarding Mobile Station 1401 in order to facilitate network functionality. SGSN 1442 may store subscription information such as, but not limited to, the International Mobile Subscriber Identity (IMSI), temporary identities, or Packet Data Protocol (PDP) addresses. SGSN 1442 may also store location information such as, but not limited to, the Gateway GPRS Support Node (GGSN) 1444 address for each GGSN where an active PDP exists. GGSN 1444 may implement a location register function to store subscriber data it receives from SGSN 1442 such as subscription or location information.

Serving Gateway (S-GW) 1443 is an interface which provides connectivity between E-UTRAN 1430 and Core Network 1440. Functions of S-GW 1443 include, but are not limited to, packet routing, packet forwarding, transport level packet processing, event reporting to Policy and Charging Rules Function (PCRF) 1450, and mobility anchoring for inter-network mobility. PCRF 1450 uses information gathered from S-GW 1443, as well as other sources, to make applicable policy and charging decisions related to data flows, network resources and other network administration functions. Packet Data Network Gateway (PDN-GW) 1445 may provide user-to-services connectivity functionality including, but not limited to, network-wide mobility anchoring, bearer session anchoring and control, and IP address allocation for PS domain connections.

Home Subscriber Server (HSS) 1463 is a database for user information, and stores subscription data regarding Mobile Station 1401 or User Equipment 1402 for handling calls or data sessions. Networks may contain one HSS 1463 or more if additional resources are required. Example data stored by HSS 1463 include, but is not limited to, user identification, numbering and addressing information, security information, or location information. HSS 1463 may also provide call or session establishment procedures in both the PS and CS domains.

The VLR/MSC Server 1460 provides user location functionality. When Mobile Station 1401 enters a new network location, it begins a registration procedure. A MSC Server for that location transfers the location information to the VLR for the area. A VLR and MSC Server may be located in the same computing environment, as is shown by VLR/MSC Server 1460, or alternatively may be located in separate computing environments. A VLR may contain, but is not limited to, user information such as the IMSI, the Temporary Mobile Station Identity (TMSI), the Local Mobile Station Identity (LMSI), the last known location of the mobile station, or the SGSN where the mobile station was previously registered. The MSC server may contain information such as, but not limited to, procedures for Mobile Station 1401 registration or procedures for handover of Mobile Station 1401 to a different section of the Core Network 1440. GMSC Server 1461 may serve as a connection to alternate GMSC Servers for other mobile stations in larger networks.

Equipment Identity Register (EIR) 1462 is a logical element which may store the International Mobile Equipment Identities (IMEI) for Mobile Station 1401. In a typical embodiment, user equipment may be classified as either “white listed” or “black listed” depending on its status in the network. In one embodiment, if Mobile Station 1401 is stolen and put to use by an unauthorized user, it may be registered as “black listed” in EIR 1462, preventing its use on the network. Mobility Management Entity (MME) 1464 is a control node which may track Mobile Station 1401 or User Equipment 1402 if the devices are idle. Additional functionality may include the ability of MME 1464 to contact an idle Mobile Station 1401 or User Equipment 1402 if retransmission of a previous session is required.

Mobility based location determination as describe herein may be implemented in software and/or in a combination of software and hardware, such as, for example, using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed processes.

The processor executing the computer readable or software instructions relating to the above described processes may be perceived as a programmed processor or a specialized processor.

While example configurations and aspects of mobility based location determination have been described in connection with various computing devices/processors, the underlying concepts may be applied to any computing device, processor, or system capable of facilitating mobility based location determination, as described herein. The various techniques described herein may be implemented in connection with hardware or software or, where appropriate, with a combination of both. Thus, the methods and apparatuses of a mobility based location determination, or certain aspects or portions thereof, may take the form of program code (i.e., instructions) embodied in tangible storage media having a concrete, tangible, physical structure. Examples of tangible storage media may include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture having a concrete, tangible, physical structure. When the program code is loaded into and executed by a machine, such as a computer, the machine becomes an apparatus for mobility based location determination, as described herein. In the case of program code executing on programmable computers, the computing device generally may include a processor, a storage medium readable by the processor (including volatile and non-volatile memory and/or storage elements), at least one input device, and at least one output device. The program(s) can be implemented in assembly or machine language, if desired. The language may be a compiled or interpreted language, and combined with hardware implementations.

The methods and apparatuses associated with mobility based location determination, as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for implementing mobility based location determination, as described herein. When implemented on a general-purpose processor, the program code combines with the processor to provide a unique apparatus that operates to invoke the functionality of mobility based location determination, as described herein.

While mobility based location determination has been described in connection with the various embodiments of the various figures, it is to be understood that other similar embodiments may be used or modifications and additions may be made to the described embodiments of mobility based location determination without deviating therefrom. Therefore, mobility based location determination, as described herein, should not be limited to any single embodiment, but rather should be construed in breadth and scope in accordance with the appended claims.

What is claimed:

1. An apparatus comprising:
a processor; and
memory coupled to the processor, the memory comprising executable instructions that when executed by the processor cause the processor to effectuate operations comprising:
receiving device data;
performing geospatial filtering on at least a portion of the received device data to determine a probability of the device being within a geographic region;
determining, based on the received device data, a mobility status of the device; and
determining that the device is within the geographic region based on:
the probability being greater than or equal to a threshold probability; and
the mobility status being an acceptable mobility status.

2. The apparatus of claim 1, the operations further comprising:
determining that the device is not within the geographic region based on at least one of:
the probability being less than to a threshold probability; or
the mobility status being an unacceptable mobility status.

3. The apparatus of claim 1, wherein:
an acceptable mobility status is indicative of the device being stationary; and
an un acceptable mobility status is indicative of the device being nonstationary; and

[symbol]

4. The apparatus of claim 1, wherein the device data comprises:
an identification of the device;
a location record for device; and
an accuracy level associated with the location record of the device.

5. The apparatus of claim 4, the operations further comprising identifying, based on the location record, a bin in a database;
identifying, at least one first geofence in which the bin is located;
identifying, based on the identification of the device, at least one second geofence that is associated with the device;
determining an intersection of the at least one first geofence and the at least one second geofence; and
determining, the probability of the device being in the geographic region based on the determined intersection.

6. The apparatus of claim 5, wherein:
the probability of the device being in the geographic region is further based on an accuracy level associated with the location record of the device.

7. The apparatus of claim 1, wherein:
the device data comprises an accuracy level associated with a location of the device; and
the probability of the device being within the geographic region is based on the accuracy level.

8. A method comprising:
receiving, by a processor, device data;
performing, by the processor, geospatial filtering on at least a portion of the received device data to determine a probability of the device being within a geographic region;
determining, by the processor, based on the received device data, a mobility status of the device; and
determining, by the processor, that the device is within the geographic region based on:
the probability being greater than or equal to a threshold probability; and
the mobility status being an acceptable mobility status.

9. The method of claim 8, further comprising:
determining that the device is not within the geographic region based on at least one of:
the probability being less than to a threshold probability; or
the mobility status being an unacceptable mobility status.

10. The method of claim 8, wherein:
an acceptable mobility status is indicative of the device being stationary; and
an un acceptable mobility status is indicative of the device being nonstationary; and

[symbol]

11. The method of claim 8, wherein the device data comprises:
an identification of the device;
a location record for device; and
an accuracy level associated with the location record of the device.

12. The method of claim 11, further comprising
identifying, based on the location record, a bin in a database;
identifying, at least one first geofence in which the bin is located;
identifying, based on the identification of the device, at least one second geofence that is associated with the device;
determining an intersection of the at least one first geofence and the at least one second geofence; and
determining, the probability of the device being in the geographic region based on the determined intersection.

13. The method of claim 12, wherein:
the probability of the device being in the geographic region is further based on an accuracy level associated with the location record of the device.

14. The method of claim 8, wherein:
the device data comprises an accuracy level associated with a location of the device; and
the probability of the device being within the geographic region is based on the accuracy level.

15. A computer-readable storage medium comprising executable instructions that when executed by a processor cause the processor to effectuate operations comprising:
receiving device data;
performing geospatial filtering on at least a portion of the received device data to determine a probability of the device being within a geographic region;
determining, based on the received device data, a mobility status of the device; and
determining that the device is within the geographic region based on:
the probability being greater than or equal to a threshold probability; and
the mobility status being an acceptable mobility status.

16. The computer-readable storage medium of claim 15, the operations further comprising:
determining that the device is not within the geographic region based on at least one of:
the probability being less than to a threshold probability; or
the mobility status being an unacceptable mobility status.

17. The computer-readable storage medium of claim 15, wherein:
an acceptable mobility status is indicative of the device being stationary; and
an un acceptable mobility status is indicative of the device being nonstationary; and

[symbol]

18. The computer-readable storage medium of claim 15, the device data comprising an identification of the device, a location record for device, and an accuracy level associated with the location record of the device, the operations further comprising
identifying, based on the location record, a bin in a database;
identifying, at least one first geofence in which the bin is located;
identifying, based on the identification of the device, at least one second geofence that is associated with the device;
determining an intersection of the at least one first geofence and the at least one second geofence; and
determining, the probability of the device being in the geographic region based on the determined intersection.

19. The computer-readable storage medium of claim 18, wherein:
the probability of the device being in the geographic region is further based on an accuracy level associated with the location record of the device.

20. The computer-readable storage medium of claim 15, wherein:
the device data comprises an accuracy level associated with a location of the device; and
the probability of the device being within the geographic region is based on the accuracy level.
